(19) United States
(12) Patent Application Publication
(10) Pub. No.: US 2009/0179358 A1
(43) Pub. Date: Jul. 16, 2009

(54) METHOD AND APPARATUS FOR PRODUCING SATURATED NORBORNENE RESIN FILM AND METHOD FOR PRODUCING STRETCHED SATURATED NORBORNENE RESIN FILM

(75) Inventor: Masaaki OTOSHI, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/353,731

(22) Filed: Jan. 14, 2009

(30) Foreign Application Priority Data
Jan. 15, 2008 (JP) 2008-005919

(51) Int. Cl. B29C 47/00

(52) U.S. Cl. 264/449; 264/211.12; 425/144; 425/174.6

(57) ABSTRACT

An aspect of the present invention provides a method for producing a saturated norbornene resin film by melt film-forming method comprising discharging a molten resin molten in an extruder in a form of a sheet onto a traveling or rotating cooling support from a die so as to be solidified by cooling, wherein the molten resin discharged from the die is subjected to a close contact treatment which allows only the both end parts of the full width of the molten resin to closely contact to the cooling support. According to the aspect, a close contact treatment which allows only the both end parts of the full width of the molten resin discharged from the die to closely contact to the cooling support is conducted in the melt film-forming of a saturated norbornene resin film, a saturated norbornene resin film having an excellent surface quality without the surface quality defects such as step irregularities can be produced.

### BACKGROUND OF THE INVENTION

1. Field of the Invention

The present invention relates to a method and an apparatus for producing a saturated norbornene resin film and a method for producing a stretched saturated norbornene resin film and particularly relates to technology to produce a saturated norbornene resin film before stretching of a stretched saturated norbornene resin film having a quality suitable for a liquid crystal display device by a melt film-forming method.

2. Description of the Related Art

Conventionally, stretching of thermoplastic resin films such as saturated norbornene resin films has been carried out to develop in-plane retardation (Re) and thickness direction retardation (Rth) so as to use the films as retardation films for liquid crystal display elements for the purpose of widening viewing angle.

Examples of the methods for stretching such thermoplastic resin films include a method (longitudinal stretching) in which a film is stretched along the longitudinal direction (length direction) of the film, a method (transverse stretching) in which a film is stretched along the transverse direction (width direction) of the film, and a method (simultaneous stretching) in which the longitudinal stretching and the transverse stretching are simultaneously applied. Among these, the longitudinal stretching has been frequently used conventionally since the equipment for longitudinal stretching is compact. Usually, the longitudinal stretching is a method in which a film is heated to a temperature equal to or higher than the glass transition temperature (Tg) of the film between two or more pairs of nip rolls while the conveying speed of the nip roll on the outlet side is set to be faster than that of the niproll on the entry side, thereby stretching the film longitudinally.

A method in which a cellulose ester is longitudinally stretched is described in Japanese Patent Application Laid-Open No. 2002-311240. The method of Japanese Patent Application Laid-Open No. 2002-311240 improves angle unevenness of the slow axis by setting the longitudinal stretching direction to be opposite to the flow-cast film-forming direction. Additionally, Japanese Patent Application Laid-Open No. 2003-315551 describes a method in which stretching is conducted with nip rolls disposed in the stretching zone so that they may have a short span of 0.3 or more and 2 or less in terms of the longitudinal-to-transverse ratio (L/W). According to the method of Japanese Patent Application Laid-Open No. 2003-315551, thickness direction orientation (Rth) can be improved. The longitudinal-to-transverse ratio as referred to herein represents a value obtained by dividing the separation (L) between the nip rolls used for stretching by the width (W) of the thermoplastic resin film to be stretched.

In the meantime, when a saturated norbornene resin film (before stretching) is film-formed by a melt film-forming method, it becomes important that shrinkage in the width direction and surface quality defects such as irregularities in thickness and streaks do not occur in the film-forming process. The occurrence of the surface quality defects is mainly caused by air which enters in between the molten resin in the form of a sheet and the cooling support when the molten resin is discharged from a die in the form of a sheet onto the cooling support (for example, onto rotating cooling rolls) and deteriorates the close contact of the resin and the support.

As a technique which prevents air from getting in between the molten resin in the form of a sheet and a cooling drum conventionally in melt film-forming methods, for example, a film making machine of Japanese Patent Application Laid-Open No. 2004-255720 has been suggested. According to this film making machine, the surface of the cooling rolls is subjected to pearskin finish and besides, both an electrostatic pinning device which allows the molten resin discharged from the die to closely contact with the cooling rolls across the full width of the resin and an electrostatic edge pinning device which allows the molten resin to closely contact with the cooling rolls at the both end parts in the width direction are provided, and thus it is suggested that air is hard to get in between the molten resin and the cooling rolls. It is disclosed that this enables to make a clear film without shrinkage in the width direction even if the molten resin is taken up at a high speed not less than 30 m/min. In addition, there is described that good results were obtained in working examples using PET (polyethylene terephthalate) resin as molten resin.

### SUMMARY OF THE INVENTION

However, when the technique of Japanese Patent Application Laid-Open No. 2004-255720 is carried out using a resin for a saturated norbornene resin film, which the applicants intend to produce, there are problems that surface quality defects, particularly step irregularities in which thick parts and thin parts are formed alternately in the width direction are caused and thus a saturated norbornene resin film having an excellent surface quality cannot be film-formed. That is, resins commonly referred to as molten resins have various specific properties depending on the kind of the resins and even if the technique of Japanese Patent Application Laid-Open No. 2004-255720 is applicable to PET resin, it is not applicable to a saturated norbornene resin film different in the properties of the resin.

The present invention has been made in view of such circumstances and aims at providing a method and an apparatus for producing a saturated norbornene resin film which are capable of conspicuously improving the surface quality of a saturated norbornene resin film produced by melt film-forming method and a stretched saturated norbornene resin film obtained by stretching the saturated norbornene resin film.

To attain the above object, a first aspect of the present invention provides a method for producing a saturated norbornene resin film by melt film-forming method which comprises discharging a molten resin molten in an extruder in a form of a sheet onto a traveling or rotating cooling support from a die so as to be solidified by cooling, characterized in that the molten resin discharged from the die is subjected to a close contact treatment which allows only the both end parts of the full width of the molten resin to closely contact to the cooling support.

The present inventors have intensively studied on the relation between the close contact conditions of a molten resin in the form of a sheet discharged from the die and a cooling support and the surface quality of the formed film. As a result, it has been found that close contact conditions different from those of polyester resins such as PET are necessary for the improvement of the surface quality when the molten resin is a saturated norbornene resin film and that such a close contact treatment as in the case of PET which treatment allows the molten resin to closely contact with a cooling support across the full width of the resin will rather deteriorate the surface quality. That is, in the case of a resin for a saturated norbornene resin film, a saturated norbornene resin film having an excellent surface quality can be produced by conducting a close contact treatment which allows only the both end parts of the full width of the molten resin discharged from the die to closely contact to the cooling support while particularly not conducting a close contact treatment for the middle part of the molten resin in the transverse direction.

According to the first aspect of the present invention, a close contact treatment which allows only the both end parts of the full width of the molten resin discharged from the die to closely contact to the cooling support is conducted in the melt film-forming of a saturated norbornene resin film, a saturated norbornene resin film having an excellent surface quality without the surface quality defects such as step irregularities can be produced. In this case, when a close contact treatment across full width of the molten resin is conducted as in Japanese Patent Application Laid-Open No. 2004-255720, surface quality defects such as step irregularities occur. On the other hand, when no close contact treatment is conducted across full width of the molten resin, air is extremely easy to get in between the molten resin and the cooling support, and therefore, the film may shrink in the width direction and surface quality defects such as irregularities in thickness and streaks occur as described in the description of the related art.

A second aspect of the present invention is, in the first aspect of the present invention, characterized in that the close contact treatment is a treatment which charges the both end parts of the molten resin in the width direction with static electricity to allow only the both end parts of the full width of the molten resin to closely contact to the cooling support by the charged static electricity.

Charging the both end parts in the width direction of the molten resin discharged from the die in a form of a sheet with static electricity in this way enables the molten resin to be solidified by cooling in a condition that only the both end parts of the full width of the molten resin is allowed to closely contact to the cooling support while the middle part in the width direction of the molten resin is not allowed to closely contact to the cooling support. This enables to produce a saturated norbornene resin film excellent in surface quality.

A third aspect of the present invention is, in the first or second aspect of the present invention, characterized in that the relation between orientation in the width direction (TD direction) and orientation in the film flow direction (MD direction) of the saturated norbornene resin film which is formed by conducting the close contact treatment is a relation in which the orientation in the MD direction is larger than the orientation in the TD direction.

The third aspect of the present invention shows a relation between the orientation in the MD direction and the orientation in the TD direction of the saturated norbornene resin film which is formed by conducting the close contact treatment which allows only the both end parts of the full width of the molten resin discharged from the die to closely contact to the cooling support.

The film of the molten resin which touches down to the cooling support is subjected to a tension which draws the film in the flow direction (MD direction) of the film, and thereby the film is mainly oriented in the MD direction. On the other hand, the film having touched down to the cooling support is liable to shrink in the TD direction due to the cooling of the film and the tension mentioned above, which is restricted by a close contact treatment. Since a shrinkage stress occurred by this restriction is imposed to the film, the film is oriented in the TD direction. Therefore, the larger the degree of the close contact is and the larger the shrinkage stress is, the larger the orientation in the TD direction is. Thus, the present inventors have found that the higher close contact in the close contact treatment is not simply proportionally better but that the close contact treatment is preferably conducted so that the orientation in the MD direction may be larger than the orientation in the TD direction for the purpose of preventing surface quality defects.

In addition, the saturated norbornene resin is mainly used for optical use, and it is advantageous that the orientation in the MD direction is larger than the orientation in the TD direction so as to get useful characteristic as optical use.

That is, a close contact treatment state which is optimal for the prevention of surface quality defects and a saturated norbornene resin film which is useful as a film for optical use can be obtained by allowing the relation between orientation in the width direction (TD direction) and orientation in the film flow direction (MD direction) of the saturated norbornene resin film which is formed by conducting the close contact treatment to be a relation in which the orientation in the MD direction is larger than the orientation in the TD direction.

A fourth aspect of the present invention is, in the second or third aspect of the present invention, characterized in that an electrode including one or more needle-like projections is used to charge the static electricity.

Only the both end parts of the full width of a molten resin can be closely contacted to the cooling support at an appropriate close contact degree by charging static electricity using an electrode including one or more needle-like projections. This enables to produce a saturated norbornene resin film excellent in surface quality.

A fifth aspect of the present invention is, in the fourth aspect of the present invention, characterized in that a voltage of 2 to 20 kV is applied to the electrode.

The molten resin can be closely contacted to the cooling support at an appropriate close contact degree by adjusting the voltage applied to the electrode to 2 to 20 kV. This enables to produce a saturated norbornene resin film excellent in surface quality.

A sixth aspect of the present invention is, in any one of the first to fifth aspects of the present invention, characterized in that an atmospheric temperature around the molten resin in the course of leaving the die to touching down on the cooling support is controlled to a range of glass transition temperature of the molten resin (Tg)−10° C. to Tg+50° C.

This is because when the atmospheric temperature around the molten resin exceeds the glass transition temperature of the molten resin (Tg)+50° C., adhesiveness of the molten resin which is discharged from the die and touches down to the cooling support is so large that the close contact degree not only the both end parts of the molten resin in the width direction but also the middle part becomes high, and close contact only at the both end parts in the width direction cannot be achieved by the close contact treatment.

On the other hand, when the atmospheric temperature around the molten resin is less than the glass transition temperature (Tg)−10° C. of the molten resin, the molten resin discharged from the die is cooled and increases in viscosity before the resin touches down to the cooling support, and thus retardation (Re) develops although it is not yet stretched.

A seventh aspect of the present invention is, in any one of the first to sixth aspects of the present invention, characterized in that the temperature of the cooling support is in a range of glass transition temperature of the molten resin (Tg) to Tg−30° C., and the cooling support has a traveling or rotating speed in a range of 1 to 50 m/min.

This is because when the temperature of the cooling support is too high exceeding the glass transition temperature of the molten resin (Tg), adhesiveness of the molten resin which touches down to the cooling support is so large that close contact only at the both end parts in the width direction cannot be achieved by the close contact treatment. On the other hand, when the temperature of the cooling support is too low below the glass transition temperature of the molten resin Tg−30° C., transverse step irregularity is liable to develop.

In addition, when the traveling or rotating speed of the cooling support is too high surpassing 50 m/min, cooling of the molten resin becomes insufficient and streak troubles caused by the slip of the molten resin on the cooling support is liable to occur, while productivity extremely falls when the speed is less than 1 m/min.

An eighth aspect of the present invention is, in any one of the first to seventh aspects of the present invention, characterized in that the lip clearance of the die is set in a range of 300 to 1500 μm, and the lip clearance ratio (D/W) which is a ratio of the lip clearance (D) of the die to the thickness (W) of the molten resin discharged from the die is set to a range of 1.5 to 10.

This is because when the lip clearance of the die is less than 300 μm, the molten resin sticks to the lip surface (the lip land part of the slit exit) of the die, and surface quality defects such as streak troubles are liable to occur by an encrustation. On the other hand, when the lip clearance of the die exceeds 1,500 μm, the draw ratio rises so much that the width of the saturated norbornene resin film produced becomes small.

In addition, when the lip clearance ratio (D/W) is less than 1.5, surface roughness is liable to occur on the surface of the molten resin, and when the lip clearance ratio (D/W) exceeds 10, retardation (Re) develops although it is a saturated norbornene resin film before stretching.

A ninth aspect of the present invention is, in any one of the first to eighth aspects of the present invention, characterized in that the discharging angle to discharge the molten resin from the die is set in a range of 0° to 45° along a traveling or rotating direction of the cooling support assuming that the vertical direction is 0°.

The molten resin in the form of a sheet which touches down to the traveling or rotating cooling support from the die forms a film in the form of a sheet which slants toward the traveling or rotating direction between the die lip and the landing point. Therefore, when the discharge direction of the die is inclined beforehand in accordance with the sloping film, the molten resin is hard to stick to the lip surface of the die. However, when the discharging angle exceeds 45°, the molten resin is liable to touch the lip surface at the time of starting the melt film-forming operation. A preferable discharging angle is 1 to 45°.

A tenth aspect of the present invention is, in any one of the first to ninth aspects of the present invention, characterized in that the centerline average roughness (Ra) of the lip surface of the die is not more than 0.5 μm and the curvature radius (R) of an edge part of the lip on the discharge outlet side is not more than 50 μm.

This is because when the molten resin is discharged from the die to the atmosphere with a discharge pressure, the molten resin slightly swells and it is liable to touch the lip surface. Therefore, when the surface roughness of the lip surface is large, the molten resin is liable to stick when it comes into contact, which may cause streak troubles. And development of streak troubles increases when the centerline average roughness (Ra) of the lip surface exceeds 0.5 μm. In addition, when the curvature radius of the edge part of the lip on the discharge outlet side exceeds 50 μm, streak troubles may be caused.

An eleventh aspect of the present invention is, in any one of the first to tenth aspects of the present invention, characterized in that the hardness of the lip surface of the die is not less than 500 in terms of Vickers hardness.

This is because when the hardness of the lip surface of the die is less than 500 in terms of Vickers hardness, the lip surface is easy to be damaged, and streak troubles caused by this damage are liable to occur.

A twelfth aspect of the present invention is, in any one of the first to eleventh aspects of the present invention, characterized in that the saturated norbornene resin is a copolymer of norbornene and ethylene.

It is easy to treat a saturated norbornene resin which is a copolymer of norbornene and ethylene, and the saturated norbornene resin film of a copolymer of norbornene and ethylene has characteristics of being easy to be stretched and excellent in moisture-proof property.

A thirteenth aspect of the present invention is characterized in that a saturated norbornene resin film before stretching produced by any one of the first to twelfth aspects of the present invention is stretched at least one direction of the longitudinal direction and the transverse direction of the film by not less than 1% and not more than 300%.

The thirteenth aspect of the present invention is a method for producing a stretched saturated norbornene resin film obtained by stretching a saturated norbornene resin film produced by any one of the production methods of the first to twelfth aspects of the present invention, and a stretched saturated norbornene resin film excellent in surface quality can be produced by using a saturated norbornene resin film of the present invention.

A fourteenth aspect of the present invention is, in the thirteenth aspect of the present invention, characterized in that the stretching results in an in-plane retardation (Re) of not less than 50 nm.

Since the in-plane retardation (Re) of not less than 50 nm can be achieved by stretching a saturated norbornene resin film produced by the present invention, it can be preferably used for a liquid crystal display element.

A fifteenth aspect of the present invention is a polarizing plate characterized in that at least one layer of a saturated norbornene resin film produced by any one of the first to twelfth aspects of the present invention is laminated; a sixteenth aspect of the present invention is an optical compensation film for a liquid crystal display board in which a saturated norbornene resin film produced by any one of the first to twelfth aspects of the present invention is used as a base material; and a seventeenth aspect of the present invention is an anti-reflection film in which a saturated norbornene resin film produced by any one of the first to twelfth aspects of the present invention is used as a base material. In addition, an eighteenth aspect of the present invention is a polarizing plate in which at least one layer of a stretched saturated norbornene resin film produced by the thirteenth or fourteenth aspect of the present invention is laminated; and a nineteenth aspect of the present invention is an optical compensation film for a liquid crystal display board in which a stretched saturated norbornene resin film produced by the thirteenth or fourteenth aspect of the present invention is used as a base material; and a twentieth aspect of the present invention is an anti-reflection film in which a stretched saturated norbornene resin film produced by the thirteenth or fourteenth aspect of the present invention is used as a base material.

To attain the above object, a twenty-first aspect of the present invention provides an apparatus for producing a saturated norbornene resin film by melt film-forming method which comprises discharging a molten resin molten in an extruder in a form of a sheet onto a traveling or rotating cooling support from a die so as to be solidified by cooling, the apparatus comprising:

a device for performing close contact treatment at both end parts which allows only the both end parts of the full width of the molten resin discharged from the die to closely contact to the cooling support, and

a device for regulating atmospheric temperature which regulates an atmospheric temperature around the molten resin in the course of leaving the die to touching down on the cooling support.

The twenty-first aspect of the present invention is an aspect which constitutes the present invention as an apparatus. Since the apparatus is constructed so that it may allow only the both end parts of the full width of the molten resin discharged from the die to closely contact to the cooling support by the device for performing close contact treatment at both end parts and may regulate an atmospheric temperature around the molten resin in the course of leaving the die to touching down on the cooling support at a predetermined temperature by the device for regulating atmospheric temperature, surface quality of a saturated norbornene resin film produced by the melt film-forming method can be conspicuously improved.

A twenty-second aspect of the present invention is, in the twenty-first aspect of the present invention, characterized in that the device for regulating atmospheric temperature comprises a surrounding member which surrounds the molten resin in the course of leaving the die to touching down on the cooling support, a heating device which heats the surrounding member, a temperature sensor which measures the atmospheric temperature within the surrounding member, and a controlling device which controls heating temperature of the heating device based on the atmospheric temperature measured with the temperature sensor.

The twenty-second aspect of the present invention is an aspect which shows a preferable construction of the device for regulating the atmospheric temperature.

According to the present invention, surface quality of a saturated norbornene resin film produced by the melt film-forming method can be improved conspicuously. On this account, the surface quality of the stretched saturated norbornene resin film produced by stretching a saturated norbornene resin film before this stretching is also improved.

### BRIEF DESCRIPTION OF THE DRAWINGS

FIG. 1 illustrates a total constitution of the film production apparatus to which the present invention is applied;

FIG. 2 is a schematic view illustrating the constitution of a device for achieving close contact at both end parts and a device for regulating atmospheric temperature provided in the film-forming step part;

FIG. 3 is a schematic view illustrating the discharging angle of the die and the lip clearance ratio;

FIG. 4 is a schematic view illustrating the hardness of the die lip and the curvature radius of the edge part;

FIG. 5 is a schematic view illustrating the constitution of an extruder; and

FIGS. 6A and 6B are tables illustrating the Examples of the present invention.

### DETAILED DESCRIPTION OF THE PREFERRED EMBODIMENTS

Hereinbelow, preferable embodiments of the method and apparatus for producing a saturated norbornene resin film and the method for producing a stretched saturated norbornene resin film according to the present invention are described referring to the attached drawings.

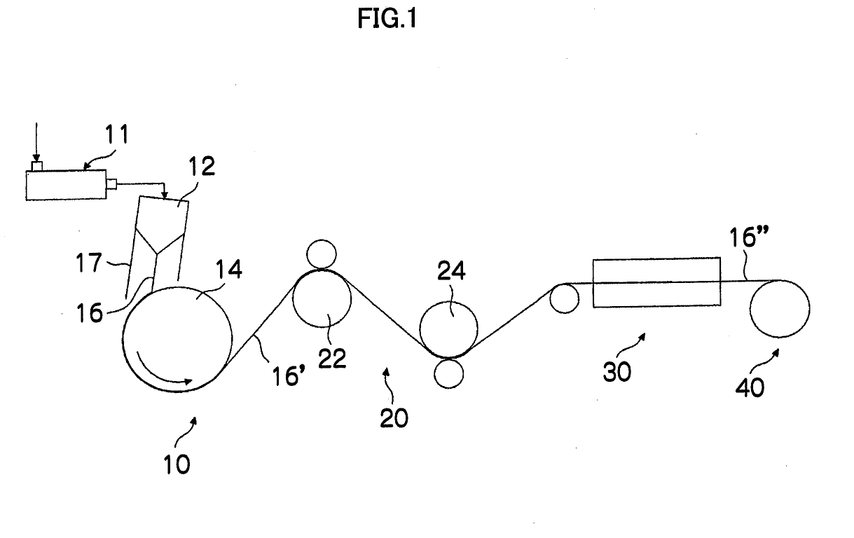

FIG. 1 illustrates an example of the schematic constructions of the production apparatus of a stretched saturated norbornene resin film.

The production apparatus mainly includes a film-forming step part 10 which produces a saturated norbornene resin film before stretching; a longitudinal stretching step part 20 which longitudinally stretches the saturated norbornene resin film before stretching produced in the film-forming step part 10; a transverse stretching step part 30 which longitudinally stretches the film; and a taking-up step part 40 as shown in FIG. 1.

In the film-forming step part 10, a saturated norbornene resin 16 (hereinbelow referred to as a “molten resin 16”) molten in an extruder 11 is discharged from a die 12 in a form of a sheet and cast onto a cooling drum 14 (cooling support) having a rotating surface which is made of a metal to be rapidly cooled and solidified. A saturated norbornene resin film 16′ is hereby film-formed. This saturated norbornene resin film 16′ is released from the cooling drum 14 and transferred sequentially to the longitudinal stretching step part 20 and the transverse stretching step part 30 to be stretched and the film is then taken up as a roll in the take-up step part 40. A stretched saturated norbornene resin film 16″ is hereby film-formed. In addition, although not illustrated, a cooling band can be used in substitution for the cooling drum 14. The cooling band is hung between a drive roller and a driven roller and travels in an oval-shaped orbit by driving the drive roller.

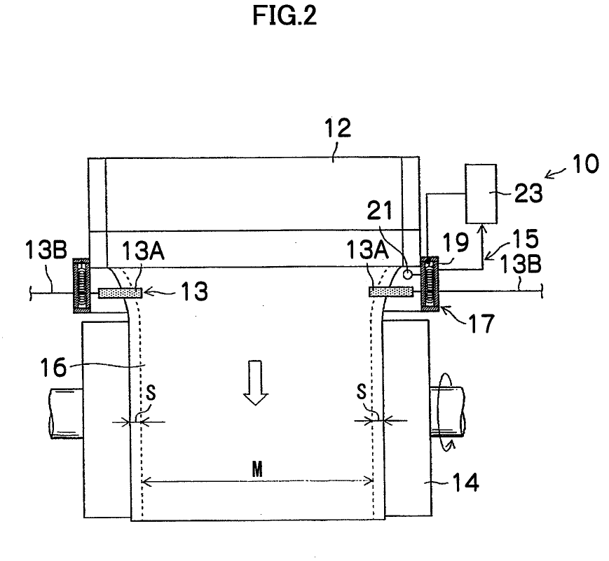

In addition, the film-forming step part 10 is provided with a device 13 for performing close contact treatment at both end parts which allows only the both end parts of the full width of the molten resin 16 discharged from the die 12 to closely contact to the cooling drum 14 and a device 15 for regulating atmospheric temperature which regulates an atmospheric temperature around the molten resin 16 in the course of leaving the die 12 to touching down on the cooling drum 14 as shown in FIG. 2.

The device 13 for performing close contact treatment at both end parts is mainly composed of a pair of electrodes 13A, 13A disposed between the die 12 and the cooling drum 14 and respectively at positions which face the both end parts of the molten resin 16 discharged from the die 12. And the pair of electrodes charges static electricity only at both end parts S of the full width of the molten resin 16 discharged from the die 12 by passing an electric current to 13A, 13A through electric wire 13B from the power-supply unit not illustrated. A close contact treatment which allows only both end parts S of the full width of the molten resin 16 discharged from the die 12 to closely contact to the cooling drum 14 is performed by this static electricity. This enables to produce a saturated norbornene resin film 16′ having a good surface quality without surface quality defects such as step irregularities. In this case, when the close contact degree in the close contact treatment by the device 13 for performing close contact treatment at both end parts is expressed by the orientation in the width direction (TD direction) and the orientation of the film flow direction (MD direction) of a film-formed saturated norbornene resin film, it is preferable to allow a close contact to such an extent that the orientation in the MD direction is larger than the orientation in the TD direction. Specifically, it is preferable to use an electrode including one or more needle-like projections for the electrode 13A, and it is preferable that the applied voltage with the electrode is 2 to 20 kV.

In this case, a tenter frame is often used in a transverse stretching step part 30, which is the post-step, and the ear part (a part held by the clip of the tenter frame) of the saturated norbornene resin film 16′ is cut off till it is finished as an end product, and therefore, the both end parts S subjected to the close contact treatment are preferably parts corresponding to the ear member in the tenter frame. In addition to charging by static electricity, air-knife method in which air is blown to the both end parts S in the width direction of the molten resin 16 which have touched down onto to the cooling drum 14 from the die 12 so that only the both end parts S in the width direction may be closely contacted to the cooling drum 14 can be employed in a device 13 for performing close contact treatment at both end parts. Both the charging by static electricity and the air-knife method can be also used together. In a word, it is important to perform close contact treatment only at the both end parts S in the width direction of the molten resin 16 and not to perform close contact treatment at the middle part M (FIG. 2) in the width direction for the purpose of improving surface quality of a saturated norbornene resin film 16′.

In addition, the atmospheric temperature regulating device 15 is provided with a tubular surrounding member 17 which surrounds the molten resin 16 from leaving the die 12 to touching down to the cooling drum 14, and the upper end of this surrounding member 17 is supported by the die 12. The surrounding member 17 is formed so as to have a double-walled structure and a heater 19 such as nichrome wires is placed inside of the double wall. In addition, a temperature sensor 21 measuring atmospheric temperature around the molten resin 16 is disposed in a space part surrounded with the surrounding member 17 in a condition of being supported by the surrounding member 17. The temperature sensor 21 and the heater 19 are connected to a temperature control device 23. The temperature control device 23 controls the atmospheric temperature of the circumference of the molten resin 16 in the course of leaving the die 12 to touching down to the cooling drum 14 to a range of the glass transition temperature of the molten resin 16 (Tg)−10° C. to Tg+50° C. In the case that a cooler is necessary besides a heater 19 in order to control the atmospheric temperature of the circumference of the molten resin 16 in the range of Tg−10° C. to Tg+50° C. mentioned above, a device which is capable of both heating and cooling is installed.

This is because when the atmospheric temperature of the circumference of the molten resin 16 exceeds the glass transition temperature of the molten resin 16 (Tg)+50° C., adhesiveness of the molten resin 16 which is discharged from the die 12 and touches down to the cooling drum 14 is so large and not only the close contact degree at the both end parts S of the molten resin 16 in the width direction but also the close contact degree at the middle part M becomes high, and it becomes impossible to closely contact only at the both end parts S in the width direction by the close contact treatment.

In addition, when the atmospheric temperature of the circumference of the molten resin 16 is less than the glass transition temperature of the molten resin 16 (Tg)−10° C., the molten resin 16 discharged from the die 12 is cooled and increased in viscosity before touching down to the cooling drum 14. This arises a problem that retardation (Re) develops although it is before stretching. This is because when the molten resin 16 has touched down on the cooling drum 14, the molten resin 16 is drawn by rotation of the cooling drum 14, and the same effects as in the case of stretching occur, and as the viscosity of the molten resin 16 is large, stretching effects increase accordingly, and therefore a large retardation (Re) develops although it is a saturated norbornene resin film 16′ before stretching. When a large retardation (Re) develops in a saturated norbornene resin film 16′ before stretching, draw ratio does not increase or the film is liable to break at the stretching steps 20, 30 which follow, and control of the draw ratio becomes difficult. That is, when a close contact treatment to allow only the both end parts S of the molten resin 16 in the width direction to closely contact to the cooling drum 14 as in the present invention is performed, retardation (Re) is liable to develop in the film-forming step part 10 as compared to the case where the close contact treatment is not performed, and therefore, it is important to maintain the atmospheric temperature of the circumference of the molten resin 16 at a temperature not less than the glass transition temperature (Tg)−10° C. of the molten resin 16 so that the viscosity may not increase too high.

In addition, it is important to appropriately control the temperature and the rotating speed of the cooling drum 14 in addition to controlling the atmospheric temperature of the circumference of the molten resin 16 from the die 12 to the cooling drum 14 by the atmospheric temperature regulating device 15 in order to produce a saturated norbornene resin film 16′ having a good surface quality in the film-forming step part 10. That is, it is preferable that the temperature of the cooling drum 14 (drum surface temperature) is in a range of the glass transition temperature of the molten resin 16 (Tg) to Tg−30° C., and that the rotating speed of the cooling drum 14 is in a range of 1 to 50 m/min.

This is because when the temperature of the cooling drum 14 is too high exceeding the glass transition temperature of the molten resin (Tg), adhesiveness of the molten resin 16 which is discharged from the die 12 and has touched down to the cooling drum 14 grows so large, and the close contact degree not only at the both end parts S of the molten resin 16 in the width direction but also at the middle part M becomes high, and it becomes impossible to closely contact only at the both end parts S in the width direction by the close contact treatment. In addition, when the temperature of the cooling drum 14 is less than the glass transition temperature of the molten resin 16 (Tg)−30° C., the molten resin 16 which is discharged from the die 12 and has touched down to the cooling drum 14 is rapidly cooled and solidified, transverse step irregularity in which thick parts and thin parts are alternately formed in the rotating direction of the cooling drum 14 is liable to develop.

In addition, when the rotating speed of the cooling drum 14 is too high surpassing 50 m/min, cooling of the molten resin 16 becomes insufficient, and a slip of the molten resin 16 is liable to occur on the cooling drum 14. Surface quality of the produced saturated norbornene resin film deteriorates due to this slip. In addition, productivity does not rise when the rotating speed of the cooling drum 14 is too slow less than 1 m/min.

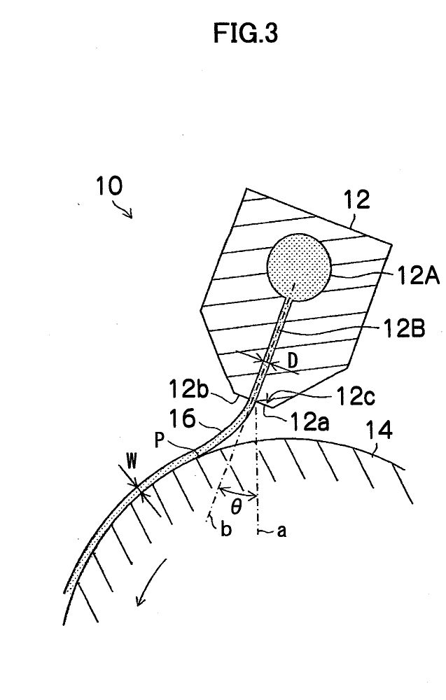

FIG. 3 illustrates a more preferable condition to improve surface quality of a saturated norbornene resin film 16′.

That is, as shown in FIG. 3, the flow of a molten resin 16 continuously supplied from an extruder 11 to a die 12 is expanded in the width direction at a manifold 12A in the die 12 and discharged from the die lip 12C (slit outlet at the die tip) through a narrow slit 12B. An upstream lip land 12a is formed on the upstream side of the rotating direction of the cooling drum 14 and a downstream side lip land 12b is formed on the downstream side of the rotating direction on the surface of the die lip 12C so that they sandwich the slit 12B. And it is preferable to set the lip clearance (D) of the die, which is a clearance width of slit 12B, to a range of 300 to 1500 μm, and the lip clearance ratio (D/W) represented by the lip clearance (D) to the thickness (W) of the molten resin 16 discharged from the die 12 to a range of 1.5 to 10.

This is because when the slit 12B is extremely narrow as in the case that the lip clearance (D) of the die 12 is less than 300 μm, the molten resin 16 sticks to the outlet of the die lip 12C and surface quality defects such as streak troubles are liable to occur by encrustation. In the meantime, when the lip clearance of the die exceeds 1,500 μm, the draw ratio rises too much, and the width of a produced saturated norbornene resin film 16′ becomes narrow.

In addition, when the lip clearance ratio (D/W) is less than 1.5, discharging speed of the molten resin 16 discharged from the die 12 is so large, and therefore the flow rate of the molten resin 16 running through the slit 12B becomes fast and surface roughness is liable to occur on the surface of the molten resin 16. On the other hand, when the lip clearance ratio (D/W) exceeds 10, the molten resin 16 is rapidly drawn by the rotation of the cooling drum 14 and large stretching effects are caused, and therefore, retardation (Re) develops although it is a saturated norbornene resin film 16′ before stretching.

In addition, as shown in FIG. 3, it is preferable to incline the discharging angle θ to discharge the molten resin 16 from the die 12 in a range of 1° to 45° along the rotating direction of the cooling drum 14 assuming the vertical direction to be 0°. Here, the discharging angle θ means the angle sandwiched between the perpendicular line a drawn from the die lip 12C in the vertical direction and an extended line b of the slit 12.

The molten resin 16 in the form of a sheet which touches down to the rotating cooling drum 14 from the die 12 forms a film in the form of a sheet slanted toward the rotating direction between die lip 12C and the landing point P. In the case that the discharging angle θ is 0°, the molten resin 16 is liable to stick to the downstream side lip land b by this mechanism. Therefore, when the discharge direction of the die 12 is inclined beforehand, the molten resin 16 is hard to stick to the downstream side lip land b, and accordingly, surface quality defects such as streak troubles caused by encrustation can be prevented. However, when the discharging angle θ is less than 1°, slant of the die 12 is insufficient and the molten resin 16 is liable to touch the downstream side lip land b. In addition, when the discharging angle θ exceeds 45°, the molten resin 16 is liable to stick to the upstream lip land 12a at the time of starting the discharge of the molten resin 16 from the die 12, and accordingly, surface quality defects such as streak troubles caused by encrustation are liable to occur by encrustation. This reason is that the tip of the molten resin 16 discharged from the die 12 has not yet touched down to the cooling drum 14 at the time of starting the operation, and accordingly the molten resin 16 will fall right below the die (the direction of perpendicular line a), and it is liable to stick to the upstream lip land 12a.

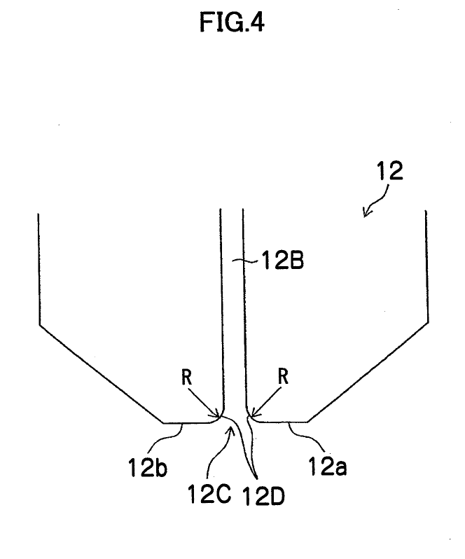

In addition, as shown in FIG. 4, it is preferable that the centerline average roughness (Ra) of the die lip 12C surface namely the lip lands 12a, 12b is less than 0.5 μm and at the same time, the curvature radius of the edge part 12D of the die lip 12C surface on the side of slit 12B is less than 50 μm.

This is because when the molten resin 16 is discharged from the die 12 to the atmosphere with a discharge pressure, the molten resin 16 slightly swells and it is liable to touch the lip lands 12a and 12b. Therefore, when the surface roughness of the lip lands 12a and 12b is large, the molten resin 16 is liable to stick when it comes into contact, which may cause streak troubles. Specifically, development of streak troubles increases when the centerline average roughness (Ra) of the lip lands 12a and 12b exceeds 0.5 μm. In addition, when the curvature radius of the edge part of the die lip 12C on the slit discharge outlet side exceeds 50 μm, streak troubles may be caused.

In addition, the hardness of the lip lands 12a and 12b is connected with surface quality of the produced saturated norbornene resin film 16′, and the hardness of the lip lands 12a and 12b is preferably not less than 500 in terms of Vickers hardness. This is because when the hardness is less than 500 in terms of Vickers hardness, the lip lands 12a and 12b are easy to be damaged, and streak troubles caused by this damage are liable to occur.

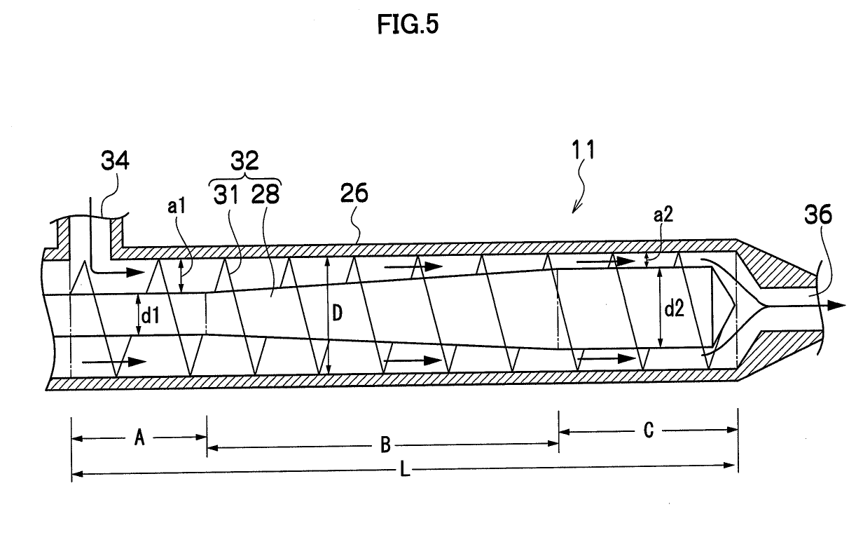

FIG. 5 is a cross-sectional view illustrating a single screw extruder 11.

As shown in FIG. 5, a single screw 32 having a flight 31 on a screw shaft 28 is disposed in a cylinder 26. A saturated norbornene resin is supplied to the cylinder 26 from a hopper not illustrated through a supply port 34. The cylinder 26 is comprised of, from the supply port 34 side, a supply unit (region represented by A) which feeds a fixed amount of a saturated norbornene resin supplied from the supply port 34, a compression unit (region represented by B) which kneads and compresses the saturated norbornene resin and a metering unit (region represented by C) which measures the kneaded and compressed saturated norbornene resin. The saturated norbornene resin molten in the extruder 11 is continuously fed to the die from a discharge port 36.

The screw compression ratio of the extruder 11 is set to 2.5 to 4.5, and the L/D′ is set to 20 to 70. Here, the screw compression ratio refers to a ratio of volume in the supply unit A to that in the metering unit C, i.e., the volume per unit length of the supply unit A divided by the volume per unit length of the metering unit C. The ratio is calculated from the outer diameter d1 of the screw shaft 28 in the supply unit A, the outer diameter d2 of the screw shaft 28 in the metering unit C, the channel diameter a1 in the supply unit A and the channel diameter a2 in the metering unit C. The L/D′ is the ratio of the cylinder length (L) to the cylinder bore diameter (D″) in FIG. 2. The extrusion temperature (outlet temperature of extruder 11) is set to 200° C. to 300° C. When the temperature in the extruder 11 is higher than 200° C., a cooler (not illustrated) may be disposed between the extruder 11 and the die 12.

The extruder 11 may be either a single screw extruder or a twin screw extruder, but when the screw compression ratio is too small less than 2.5, sufficient kneading is not achieved, and undissolved part may be resulted and/or melting of crystals becomes insufficient due to low shear heating, and minute crystals are liable to remain in a saturated norbornene resin film after production. It is also liable to involve air voids. Owing to this, when a saturated norbornene resin film is stretched, the remaining crystals inhibit stretching and orientation cannot be sufficiently enhanced. On the contrary, when the screw compression ratio is too large exceeding 4.5, excessive shear stress may cause excessive heat, by which the resin is liable to deteriorate, and the saturated norbornene resin film after the production is liable to be tinted with yellowish color. In addition, excessive shear stress may cause cleavage of molecules and decrease in the molecular weight, and the mechanical strength of the film deteriorates. Therefore, the screw compression ratio is preferably in a range of 2.5 to 4.5, more preferably in a range of 2.8 to 4.2, and particularly preferably in a range of 3.0 to 4.0 in order to prevent yellowish coloring and breakage upon stretching.

In the meantime, when L/D′ is too small less than 20, melting and/or kneading may be insufficient and minute crystals are liable to remain in a saturated norbornene resin film after the production similarly as in the case that the compression ratio is small. On the contrary, when L/D′ is too large exceeding 70, detention time of the saturated norbornene resin in the extruder 11 is excessively long and the resin is liable to deteriorate. In addition, when the detention time becomes long, cleavage of molecules and decrease in the molecular weight may be caused, and the mechanical strength of the film deteriorates. Therefore, L/D′ is preferably in a range of 20 to 70, more preferably in a range of 22 to 65, and particularly preferably in a range of 24 to 50 in order to prevent yellowish coloring and breakage upon stretching.

In the meantime, when the discharging temperature (temperature at discharge port of extruder 11) is too low less than 200° C., melting of crystals may be insufficient and minute crystals are liable to remain in a saturated norbornene resin film after the production, which inhibits stretching and orientation cannot be sufficiently enhanced when a saturated norbornene resin film is stretched. On the contrary, when the discharging temperature is too high exceeding 300° C., the saturated norbornene resin deteriorates and yellow index (YI value) turns worse. Therefore, the discharging temperature is preferably in a range of 200° C. to 300° C., more preferably in a range of 220° C. to 290° C., and particularly preferably in a range of 240° C. to 280° C. in order to prevent yellowish coloring and breakage upon stretching.

The molten resin 16 molten by the extruder 11 is continuously supplied to the die 12 and discharged from the outlet of the die 12 onto the rotating cooling drum 14 and cooled and solidified in the film-forming step part 10 in the production apparatus constructed as above. A saturated norbornene resin film 16′ before it is stretched in the longitudinal stretching step part 20 and the transverse stretching step part 30 is hereby produced.

Since the device 13 for performing close contact treatment at the both end parts is designed to perform close contact treatment to allow only the both end parts S of the full width of the molten resin 16 discharged from the die 12 to closely contact to the cooling drum 14 in the production of such a saturated norbornene resin film 16′ before stretching, a saturated norbornene resin film 16′ having a good surface quality without the surface quality defects such as step irregularities can be produced. In addition, a saturated norbornene resin film 16′ which is more oriented in the flow direction (MD direction) of the film than the width direction (TD direction) of the film can be provided by performing production in this way.

In order to improve surface quality of a saturated norbornene resin film 16′, it is preferable to carry out at least one of the following (1) to (6) in addition to the above-mentioned close contact treatment to allow only both end parts S to closely contact to the cooling drum 14.

(1) The atmospheric temperature of the circumference of the molten resin 16 in the course from leaving the die 12 to touching down to the cooling drum 14 is controlled to a range of glass transition temperature of the molten resin (Tg)−10° C. to Tg+50° C. by an atmospheric temperature regulating device 15.
(2) The temperature of the cooling drum 14 is controlled to a range of glass transition temperature of the molten resin 16 (Tg) to Tg−30° C. and the rotating speed of the cooling drum 14 is set to a range of 1 to 50 m/min.
(3) The lip clearance (d) of the die 12 is set to a range of 300 to 1500 μm and the lip clearance ratio (D/W) represented by the lip clearance (D) of the die to the thickness (W) of the molten resin 16 discharged from the die 12 is set to a range of 1.5 to 10.
(4) The die 12 is installed in a slant so that the discharging angle to discharge molten resin 16 from the die 12 is set in a range of 0° to 45° along a rotating direction of the cooling drum 14 assuming that the vertical direction is 0°.
(5) The die 12 is formed so that centerline average roughness (Ra) of the lip surface of the die 12 is equal to or less than 0.5 μm and a curvature radius of the edge part of the lip on the discharge outlet side is less than 50 μm.
(6) Hardening plating treatment is performed on the lip surface of the lip so that the hardness of the lip surface of the die 12 is not less than 500 in terms of Vickers hardness.

Needless to say, the saturated norbornene resin film produced by the production method of the present invention can be not only used as a raw material film for producing stretched saturated norbornene resin films but the saturated norbornene resin film in itself can be also used as a product.

It is preferable that a resin of the saturated norbornene resin film before stretching of the present invention film-formed in such a film-forming step part 10 is a copolymer of norbornene and ethylene. The “saturated norbornene resin” is described in more detail in the section of “saturated norbornene resins suitable for the present invention” described later.

And a saturated norbornene resin film having these property values and stretching characteristics is stretched in the longitudinal stretching step part 20 and a transverse stretching step part 30.

Hereinbelow, stretching process in which a saturated norbornene resin film produced in the film-forming step part 10 is stretched to produce a stretched saturated norbornene resin film 16″ is described.

The saturated norbornene resin film 16′ is stretched so as to orient molecules in the saturated norbornene resin film 16′ for developing in-plane retardation (Re) and thickness direction retardation (Rth). Here, the retardations Re and Rth are calculated by the following expressions.

Re(nm)=|n(MD)−n(TD)|×T(nm)

Rth(nm)=|{n(MD)+n(TD))/2}−n(TH)|×T(nm)

In the formula, n(MD), n(TD) and n(TH) are the refractive indexes in the length direction, the width direction and the thickness direction, and T is a thickness expressed in nm unit.

As shown in FIG. 1, the saturated norbornene resin film 16′ is first longitudinally stretched in the length direction in the longitudinal stretching step part 20. In the longitudinal stretching step part 20, after the saturated norbornene resin film 16′ is pre-heated, the heated saturated norbornene resin film 16′ is wound onto the two nip rolls 22 and 24. The nip roll 24 on the outlet side carries the saturated norbornene resin film 16′ at a carrying rate faster than that of the nip roll 22 on the inlet side. By this setting, the saturated norbornene resin film 16′ is stretched in the length direction.

The longitudinally stretched saturated norbornene resin film 16′ is transferred to the transverse stretching step part 30 and transversely stretched in the width direction. In the transverse stretching step part 30, a tenter, for example, can be preferably used. Using the tenter, both end parts of the saturated norbornene resin film 16′ in the width direction are held by clips and the film is stretched in the transverse direction. This transverse stretching can yield a greater retardation Rth.

It is preferable to obtain a stretched saturated norbornene resin film 16″ having an in-plane retardation (Re) of not less than 50 nm by such an stretching.

Furthermore, it is preferable that fluctuations in Re and Rth in the width direction and the length direction are respectively suppressed to not more than 5%, more preferably not more than 4% and further preferably not more than 3%.

As described above, according to this embodiment, a stretched saturated norbornene resin film 16″ is produced using a saturated norbornene resin film 16′ produced by the method of the present invention, and therefore breakage of film upon stretching hardly occurs. As a result, high stretching ratios can be achieved and control of the intended retardation (Re) is easy. Further, fluctuations in Re and Rth in the width direction and the length direction can be reduced. Consequently, a stretched saturated norbornene resin film excellent in optical properties can be produced.

Hereinbelow, saturated norbornene resins suitable for the present invention, methods of processing saturated norbornene resin films and other conditions are described in detail along the procedure.

### <<Saturated Norbornene Resins>>

Cycloolefin resins are preferable as saturated norbornene resins in the present invention and any one of cycloolefin resin-A and cycloolefin resin-B described below can be preferably used.

### (Cycloolefin Resin-A/Ring-Opening Polymerization Type)

Examples of cycloolefin resin (cycloolefin resin-A) used in the present invention include: (1) resins obtained by subjecting a polymer resulting from ring opening (co)polymerization of a norbornene monomer to polymer modification such as addition of maleic acid or addition of cyclopentadiene, as required, and then hydrogenating the modified polymer; (2) resins obtained by subjecting a norbornene monomer to addition polymerization; (3) resins obtained by subjecting a norbornene monomer and an olefin monomer such as ethylene or α-olefin to addition copolymerization. Polymerization and hydrogenation can be performed by a conventional method.

Examples of the norbornene monomers include norbornene, alkyl and/or alkylidene-substituted derivatives thereof, such as 5-methyl-2-norbornene, 5-dimethyl-2-norbornene, 5-ethyl-2-norbornene, 5-butyl-2-norbornene, 5-ethylidene-2-norbornene; derivatives thereof substituted with a polar group such as halogen; dicyclopentadiene and 2,3-dihydrodicyclopentadiene; dimethanooctahydronaphthalene, alkyl and/or alkylidene-substituted derivatives thereof and derivatives thereof substituted with a polar group such as halogen, for example, 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1, 4:5,8-dimethano-1,4,4a,5,6,7,8,8a-octahydronaphthalene, 6-cyano-1, 4:5,8-dimethano-1,4,4a,5,6,7,8,8a-octahydronaphthalene, 6-pyridyl-1, 4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; addition products of cyclopentadiene and tetrahydroindene; and trimers or tetramers of cyclopentadiene, such as 4,9:5,8-dimethano-3a,4,4a,5,8,8a,9,9a-octahydro-1H-benzoindene, 4, 11:5, 10:6,9-trimethano-3a,4,4a,5,5a,6,9,9a,10,10a, 11, 11a-dodecahydro-1H-cyclopentaanthracene.

### (Cycloolefin Resin-B/Ring-Opening Polymerization Type)

In addition, as cycloolefin resins, those represented by the following general formulas (1) to (4) may be included, and of these, a resin represented by the following general formula (1) is particularly preferable.

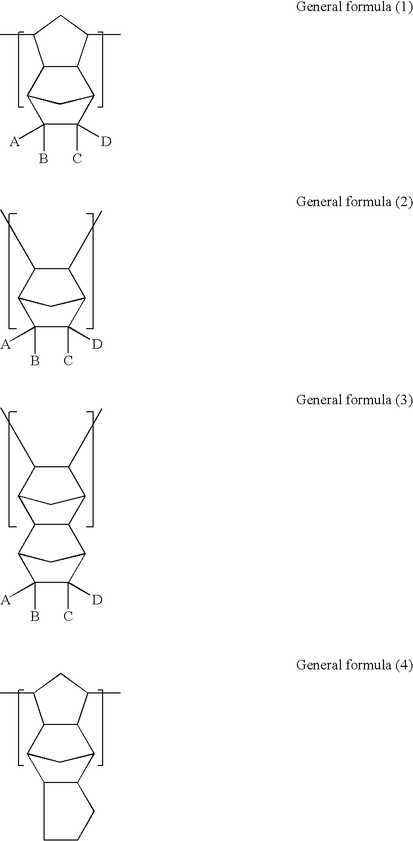

[In the general formulas (1) to (4), A, B, C and D represent a hydrogen atom or a monovalent organic group and at least one of these is a polar group.]

The weight average molecular weight of these cycloolefin resins is usually preferably 5,000 to 1,000,000 and more preferably 8,000 to 200,000.

Examples of the cycloolefin resins in the present invention include resins described in Japanese Patent Application Laid-Open No. 60-168708, Japanese Patent Application Laid-Open No. 62-252406, Japanese Patent Application Laid-Open No. 62-252407, Japanese Patent Application Laid-Open No. 2-133413, Japanese Patent Application Laid-Open No. 63-145324, Japanese Patent Application Laid-Open No. 63-264626, Japanese Patent Application Laid-Open No. 1-240517, and Japanese Examined Application Publication No. 57-8815.

Among these resins, those obtained by subjecting a norbornene monomer to addition polymerization are particularly preferable.

The glass transition temperature (Tg) of these cycloolefin resins is preferably not lower than 80° C. and not higher than 230° C., more preferably not lower than 100° C. and not higher than 200° C., still more preferably not lower than 120° C. and not higher than 180° C. The saturated water absorption is preferably not more than 1 mass %, and more preferably not more than 0.8 mass %. The glass transition temperature (Tg) and the saturated water absorption of the cycloolefin resins represented by the above general formulas (1) to (4) can be controlled by selecting the kind of substituent groups A, B, C and D.

As cycloolefin resins in the present invention, at least one kind of tetracyclododecene derivatives represented by the following general formula (5) by itself, or a hydrogenated polymer obtained by hydrogenation of a metathesis polymerized polymer of a tetracyclododecene derivative mentioned above and an unsaturated cyclic compound copolymerizable with the tetracyclododecene derivative may be used.

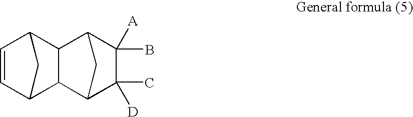

[In the formula, A, B, C and D represent a hydrogen atom or a monovalent organic group and at least one of these is a polar group.]

In the tetracyclododecene derivatives represented by the above general formula (5), since at least one of A, B, C and D is a polar group, polarization films excellent in close contact degree with the other materials, heat resistance, and so on can be obtained. Furthermore, this polar group is preferably a group represented by —(CH₂)ₙCOOR (wherein R is a hydrocarbon group having 1 to 20 carbon atoms and n represents an integer of 0 to 10.) since, in that case, the finally obtained hydrogenated polymer (base material of the polarization film) has a high glass transition temperature. It is particularly preferable that one unit of this polar substituent group represented by —(CH₂)ₙCOOR is contained per one molecule of the tetracyclododecene derivative of the general formula (5) from a viewpoint of reduction of water absorption. The hydrocarbon group represented by R in the above-mentioned polar substituent group, the more the number of carbon atoms is, the less the water absorption of the obtained hydrogenated polymer, which is preferable, but considering the balance with the glass transition temperature of the obtained hydrogenated polymer, the hydrocarbon group is preferably a linear alkyl group having 1 to 4 carbon atoms or a (poly)cyclic alkyl group having 1 to 5 carbon atoms, and a methyl group, an ethyl group and a cyclohexyl group are particularly preferable.

Furthermore, the tetracyclododecene derivative of a general formula (5) in which a hydrocarbon group having 1 to 10 carbon atoms is bonded to the carbon atom to which the group represented by —(CH2)ₙCOOR is bonded as a substituent group is preferable since, in that case, the water absorption of the obtained hydrogenated polymer is low. The tetracyclododecene derivative of the general formula (5) in which this substituent group is a methyl group or an ethyl group is particularly preferable in that the synthesis thereof is easy. Specifically, 8-methyl-8-methoxycarbonyltetracyclo[4,4,0,1^{2.5},1^{7.10}]dodec-3-ene is preferable. These tetracyclododecene derivatives and a mixture of these with an unsaturated cyclic compound which can be copolymerize with these can be metathesis polymerized or hydrogenated, for example, by methods described in page 4, upper right column, line 12 to page 6, lower right column, line 6 of Japanese Patent Application Laid-Open No. 4-77520.

These cycloolefin resins preferably have an inherent viscosity (ηinh) measured in chloroform at 30° C. of 0.1 to 1.5 dl/g, and more preferably 0.4 to 1.2 dl/g. In addition, the hydrogenation ratio of the hydrogenated polymer is 50% or more, preferably 90% or more, and still more preferably 98% or more measured by 60 MHz, ¹H-NMR. The higher the hydrogenation ratio is, the more excellent the stability against heat and light of the obtained cycloolefin film is. It is preferable that the gel content in the hydrogenated polymer is preferably 5 mass % or less, and more preferably 1 mass % or less.

Cycloolefin resins (addition polymerization type) of the following structure can be also used for a film of the present invention. In the present invention, the cycloolefin resins may include:

[A-1]: hydrogenated products of random copolymers of an α-olefin having 2 to 20 carbon atoms and a cyclic olefin represented by the following chemical formula (1), and
[A-2]: hydrogenated products of a ring-opened polymer or copolymer of a cyclic olefin represented by the following chemical formula (1).

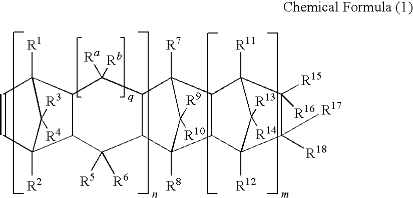

It is preferable that the glass transition temperature (Tg) of these cycloolefin resins measured by DSC is not lower than 70° C., more preferably 70 to 250° C., and particularly preferably 120 to 180° C.

In addition, these cycloolefin resins are amorphous or of low crystallinity, and the crystallinity measured by X-ray diffraction method is usually not more than 20%, preferably not more than 10%, and more preferably not more than 2%.

Besides, the limiting viscosity [η] of the cycloolefins of the present invention measured in decalin at 135° C. is usually 0.01 to 20 dl/g, preferably 0.03 to 10 dl/g, and more preferably 0.05 to 5 dl/g, and the melt flow rate (MFR) thereof measured with a load of 2.16 kg at 260° C. following ASTMD1238 is usually 0.1 to 200 g/10 min, preferably 1 to 100 g/10 min, and more preferably 5 to 50 g/10 min.

Furthermore, the softening point of the cycloolefin resins is usually not lower than 30° C., preferably not lower than 70° C., and more preferably 80 to 260° C. as a softening point measured by thermal mechanical analyzer (TMA).

The structure of the cycloolefins resin represented by the above chemical formula (1) is described in detail.

In the above chemical formula (1), n is 0 or 1, m is 0 or an integer not less than 1, and q is 0 or 1. When q is 1, R^{a} and R^{b} are each independently an atom or a hydrocarbon group shown below, and when q is 0, respective bonding hands are connected to form a five-membered ring.

R¹ to R¹⁸ and R^{a} and R^{b} are each independently a hydrogen atom, a halogen atom or a hydrocarbon group. Here, the halogen atom is a fluorine atom, a chlorine atom, a bromine atom or an iodine atom.

Typically, the hydrocarbon group may be each independently an alkyl group having 1 to 20 carbon atoms, a cycloalkyl group having 3 to 15 carbon atoms, an aromatic hydrocarbon group. Specific examples thereof include a methyl group, an ethyl group, a propyl group, an isopropyl group, an amyl group, a hexyl group, an octyl group, a decyl group, a dodecyl group and an octadecyl group as an alkyl group, a cyclohexyl group as a cycloalkyl group, and a phenyl group and a naphthyl group as an aromatic hydrocarbon group. These hydrocarbon groups may be substituted with a halogen atom(s). Furthermore in the above chemical formula (I), R¹⁵ to R¹⁸ may be bonded to each other (in conjunction with each other), to form a monocycle or polycyclic ring, and the monocyclic or polycyclic ring formed in this way may have a double bond(s).

In the following, cyclic olefins represented by the above chemical formula (1) are specifically exemplified. Examples thereof include bicyclo[2.2.1]-2-heptene (i.e. norbornene) represented by

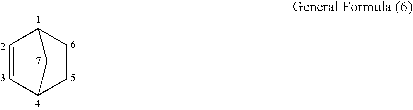

(In the above the general formula (6), the numbers of 1 to 7 denote position numbers of carbon atoms.) and derivatives obtained by substituting the compound with a hydrocarbon group.

These substituting hydrocarbon groups can be exemplified by 5-methyl, 5,6-dimethyl, 1-methyl, 5-ethyl, 5-n-butyl, 5-isobutyl, 7-methyl, 5-phenyl, 5-methyl-5-phenyl, 5-benzyl, 5-tolyl, 5-(ethylphenyl), 5-(isopropylphenyl), 5-(biphenyl), 5-(β-naphthyl), 5-α-naphthyl), 5-(anthracenyl) and 5,6-diphenyl.

Besides, other derivatives can be exemplified by bicyclo[2.2.1]-2-heptene derivatives such as a cyclopentadiene-acenaphthylene adduct, 1,4-methano-1,4,4a,9a-tetrahydrofluorene and 1,4-methano-1,4,4a,5,10,10a-hexahydroanthracene.

In addition to these, the cycloolefins include tricyclo[4.3.0.1^{2,5}]-3-decene derivatives such as tricyclo[4.3.0.1^{2,5}]-3-decene, 2-methyltricyclo[4.3.0.1^{2,5}]-3-decene and 5-methyltricyclo[4.3.0.1^{2,5}]-3-decene, tricyclo[4.4.0.1^{2,5}]-3-undecene derivatives such as tricyclo[4.4.0.1^{2,5}]-3-undecene and 10-methyltricyclo[4.4.0.1^{2,5}]-3-undecene, tetracyclo[4.4.0.1^{2,5}.1^{7,10}]-3-dodecene represented by

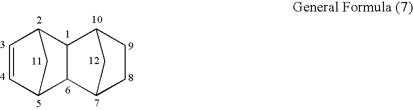

and derivatives thereof obtained by substituting with a hydrocarbon group.

The hydrocarbon groups can be exemplified by 8-methyl, 8-ethyl, 8-propyl, 8-butyl, 8-isobutyl, 8-hexyl, 8-cyclohexyl, 8-stearyl, 5,10-dimethyl, 2,10-dimethyl, 8,9-dimethyl, 8-ethyl-9-methyl, 11,12-dimethyl, 2,7,9-trimethyl, 2,7-dimethyl-9-ethyl, 9-isobutyl-2,7-dimethyl, 9,11,12-trimethyl, 9-ethyl-11,12-dimethyl, 9-isobutyl-11,12-dimethyl, 5,8,9,10-tetramethyl, 8-ethylidene, 8-ethylidene-9-methyl, 8-ethylidene-9-ethyl, 8-ethylidene-9-isopropyl, 8-ethylidene-9-butyl, 8-n-propylidene, 8-n-propylidene-9-methyl, 8-n-propylidene-9-ethyl, 8-n-propylidene-9-isopropyl, 8-n-propylidene-9-butyl, 8-isopropylidene, 8-isopropylidene-9-methyl, 8-isopropylidene-9-ethyl, 8-isopropylidene-9-isopropyl, 8-isopropylidene-9-butyl, 8-chloro, 8-bromo, 8-fluoro, 8,9-dichloro, 8-phenyl, 8-methyl-8-phenyl, 8-benzyl, 8-tolyl, 8-(ethylphenyl), 8-(isopropylphenyl), 8,9-diphenyl, 8-(biphenyl), 8-(β-naphthyl), 8-(α-naphthyl), 8-(anthracenyl) and 5,6-diphenyl.

Further, the cycloolefins may include tetracyclo[4.4.0.1^{2,5}.1^{7,10}]-3-dodecen derivatives such as an adduct of a (cyclopentadiene-acenaphthylene adduct) and cyclopentadiene, pentacyclo[6.5.1.1^{3,6}.0^{2,7}.0^{9,13}]-4-pentadecene and its derivatives, pentacyclo[7.4.0.1^{2,5}.1^{9,12}.0^{8,13}]-3-pentadecene and its derivatives, pentacyclo[8.4.0.1^{2,5}.1^{9,12}.0^{8,13}]-3-hexadecene and its derivatives, pentacyclo[6.6.1 1^{3,6}.0^{2,7}.0^{9,14}]-4-hexadecene and its derivatives, hexacyclo[6.6.1.1^{3,6}1^{10,13}.0^{2,7}.0^{9,14}]-4-heptadecene and its derivatives, heptacyclo[8.7.0.1^{2,9}.1^{4,7}.1^{11,17}.0^{3,8}.0^{12,16}]-5-eicosene and its derivatives, heptacyclo[8.7.0.1^{3,6}.1^{10,17}.1^{12,15}.0^{2,7}.0^{11,16}]-4-eicosene and its derivatives, heptacyclo[8.8.0.1^{2,9}.1^{4,7}.1^{11,18}.0^{3,8}.0^{12,17}]-5-heneicosene and its derivatives, octacyclo[8.8.0.1^{2,9}1^{4,7}.1^{11,18}.1^{13,16}.0^{3,8}.0^{12,17}]-5-docosene and its derivatives, and nonacyclo[10.9.1.1^{4,7}.1^{13,20}.1^{15,18}.0^{2,10}.0^{3,8}.0^{12,21}.0^{14,19}]-5-pentacosene and its derivative.

Specific examples of these cycloolefin resins are as described above, but more specific structures of these compounds are shown in paragraphs [0032] to [0054] of Japanese Patent Application Laid-Open No. 7-145213.

Synthesis methods of these cycloolefin resins can be performed referring to paragraphs [0039] to [0068] of Japanese Patent Application Laid-Open No. 2001-114836.

As the cycloolefin resins (addition polymerization type) of the present invention, the following can also be used.

The cycloolefin resin may be at least one type of cycloolefins copolymer selected from combinations each composed of a polymer containing a polymerization unit of at least one type of cycloolefins represented by the chemical formulas I, II, II′, III, IV, V or VI:

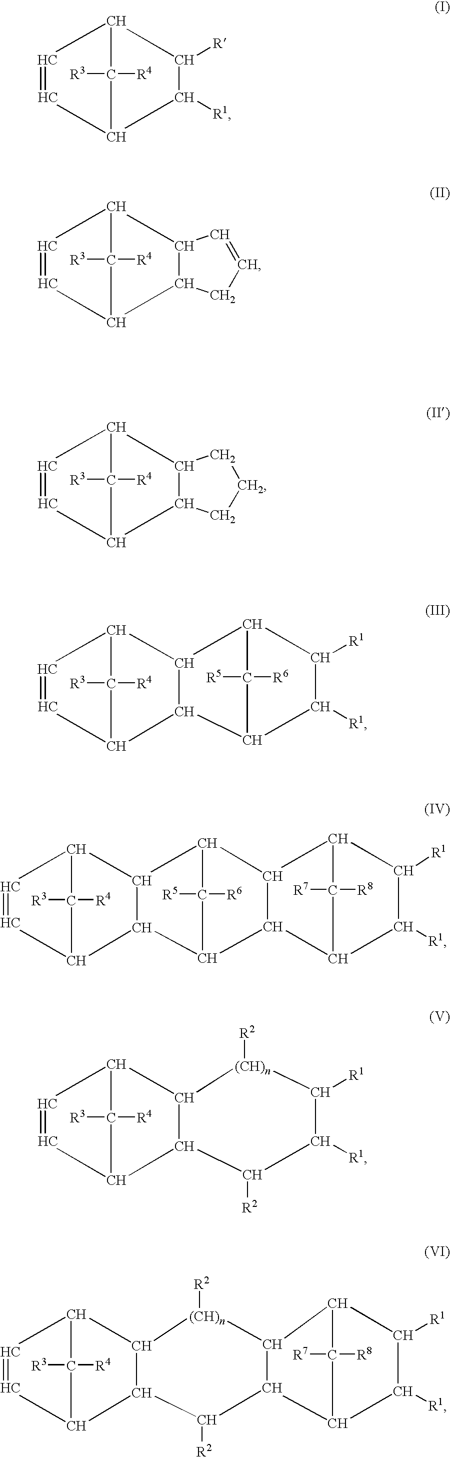

(wherein R¹, R², R³, R⁴, R⁵, R⁶, R⁷ and R⁸ are the same or different, and are a hydrogen atom or a C₁- to C₂₀-hydrocarbon group such as a linear or branched C₁- to C₈-alkyl group, a C₆- to C₁₈-aryl group, a C₇- to C₂₀-alkylenearyl group or a cyclic or noncyclic C₂- to C₂₀-alkenyl group; or R¹ to R⁸ may form a saturated, unsaturated or aromatic ring; the same R¹ to R⁸ in the chemical formulas (I) to (VI) may be different in each formula; n is 0 to 5) and a polymerization unit, of 0 to 99 mol % based on the total structure of the cycloolefin copolymer, derived from at least one type of noncyclic olefin represented by the following chemical formula VII:

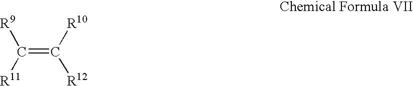

(wherein R⁹, R¹⁰, R¹¹ and R¹² are the same or different, and are a hydrogen atom or a liner or branched, saturated or unsaturated C₁- to C₂₀-hydrocarbon group such as a C₁- to C₈-alkyl group or a C₆- to C₁₈-aryl group).

Further, the cycloolefin polymer can also be obtained by subjecting at least one type of monomer represented by the chemical formulas I to VI to ring-opening polymerization and hydrogenating the obtained product.

Additionally, the cycloolefin polymer may contain a polymerization unit, of 0 to 45 mol % based on the total structure of the cycloolefin copolymer, derived from at least one type of monocyclic olefin represented by the following chemical formula VIII:

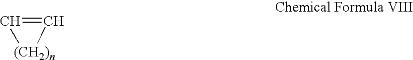

(wherein n is an integer of 2 to 10).

The proportion of the polymerization unit derived from a cyclic, particularly a polycyclic olefin is preferably 3 to 75 mol % based on the total structure of the cyclolefin copolymer. The proportion of the polymerization unit derived from a noncyclic olefin is preferably 5 to 80 mol % based on the total structure of the cycloolefin copolymer.

The cycloolefin copolymer is preferably composed of a polymerization unit derived from at least one type of polycyclic olefin, particularly polycyclic olefin represented by the chemical formula I or III and a polymerization unit derived from at least one type of noncyclic olefin, particularly α-olefin having 2 to 20 carbon atoms, represented by the chemical formula VII. Preferable is a cycloolefin copolymer composed of a polymerization unit derived from the polycyclic olefin represented by, in particularly, the chemical formula I or III and a polymerization unit derived from the noncyclic olefin represented by the chemical formula VII. Still more preferable is a terpolymer composed of a polymerization unit derived from the polycyclic monoolefin represented by the chemical formula I or III, a polymerization unit derived from the noncyclic monoolefin represented by the chemical formula VII and a polymerization unit derived from a cyclic or noncyclic olefin (polyene) containing at least two double bonds, for example, a cyclic, preferably a polycyclic diene such as a norbornadiene, particularly preferably a polycyclic alkene, for example, a vinylnorbornene carrying a C₂- to C₂₀-alkenyl group.

The cycloolefin polymer according to the present invention contains preferably an olefin having a norbornene structure as a base, particularly preferably norbornene or tetracyclododecene, if desired, vinyl norbornene or norbornadiene. Further, the cycloolefin polymer is preferably a cycloolefin copolymer containing a polymerization unit derived from a noncyclic olefin having a double bond at its terminal such as an α-olefin having 2 to 20 carbon atoms, particularly preferably ethylene or propylene. Particularly preferable are a norbornene-ethylene copolymer and a tetracyclododecene-ethylene copolymer.

Among terpolymers, particularly preferable are a norbornene-vinylnorbornene-ethylene terpolymer, a norbornene-norbornadiene-ethylene terpolymer, a tetracyclododecene-vinylnorbornene-ethylene terpolymer and a tetracyclododecene-vinyltetracyclododecene-ethylene terpolymer. The proportion of a polymerization unit derived from a polyene, preferably vinyl norbornene or norbornadiene, is 0.1 to 50 mol % based on the total structure of the cycloolefin copolymer, particularly preferably 0.1 to 20 mol %; the proportion of the noncyclic monoolefin represented by the chemical formula VII is 0 to 99 mol %, preferably 5 to 80 mol %. In the above terpolymers, the proportion is 0.1 to 99 mol % based on the total structure of the cycloolefin copolymer, preferably 3 to 75 mol %.

Preferably, the cycloolefin copolymer according to the present invention contains at least one type of cycloolefin copolymer containing a polymerization unit drivable from the polycyclic olefin represented by the formula I and a polymerization unit derived from the noncyclic olefin represented by the chemical formula VII.

Such a cycloolefin copolymer can be synthesized according to paragraphs [0019] to [0020] of Japanese Patent Application Laid-Open No. 10-168201.

### (Additives)

### (1) Antioxidants

The cycloolefinic resins in the present invention can be stabilized by adding a well-known antioxidant, for example, 2,6-di-t-butyl-4-methylphenol, 2,2′-dioxy-3,3′-di-t-butyl-5,5′-dimethylphenylmethane, tetrakis[methylene-3-(3,5-di-t-butyl-4-hydroxyphenyl)propionate]methane, 1,1,3-tris(2-methyl-4-hydroxy-5-t-buthylphenyl)butane, 1,3,5-trimethyl-2,4,6-tris(3,5-di-t-butyl-4-hydroxybenzyl)benzene, stearyl-β-(3,5-di-t-butyl-4-hydroxyphenyl)propionate, 2,2′-dioxy-3,3′-di-t-butyl-5,5′-diethylphenylmethane, 3,9-bis[1,1-dimethyl-2-[β-(3-t-butyl-4-hydroxy-5-methylphenyl)propionyloxy]ethyl], 2,4,8,10-tetraoxaspiro[5,5]undecane, tris(2,4-di-t-buthylphenyl)phosphite, cyclic neopentanetetrayl bis(2,4-di-t-buthylphenyl)phosphite, cyclic neopentanetetrayl bis(2,6-di-t-butyl-4-methylphenyl)phosphite and 2,2-methylene bis(4,6-di-t-buthylphenyl)octyl phosphite; and an ultraviolet absorbent, for example, 2,4-dihydroxybenzophenone and 2-hydroxy-4-methoxybenzophenone. Further, additives such as lubricants can also be added for improving processability.

The addition amount of these antioxidants is commonly 0.1 to 3 parts by mass to 100 parts by mass of a cycloolefinic resin, preferably 0.2 to 2 parts by mass.

Additionally, if desired, the cycloolefinic resins may be added with any of additives such as an antiaging agent such as a phenolic or phosphorous agent, an antistatic agent, an ultraviolet absorbent and a lubricant.

### (2) Stabilizers

The present invention preferably uses as a stabilizer one of or both of a phosphite-based compound and a phosphorous acid ester compound. The formulation amount of these stabilizers is 0.005 to 0.5% by mass to a cycloolefin resin, more preferably 0.01 to 0.4% by mass, still more preferably 0.02 to 0.3% by mass.

### (i) Phosphite-Based Stabilizers

Specific phosphite-based stabilizers are not especially limited, but are preferably phosphite-based stabilizers represented by the general formulas (8) to (10).

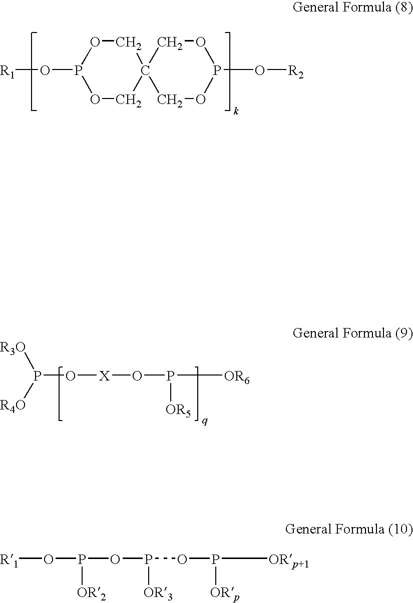

In the above each general formula, R¹, R², R³, R⁴, R⁵, R⁶, R′¹, R′², R′³ . . . R′^{p} and R′^{p+1} denote a hydrogen atom or a group selected from the group consisting of an alkyl group, an aryl group, an alkoxyalkyl group, an aryloxyalkyl group, an alkoxyaryl group, an arylalkyl group, an alkylaryl group, a polyaryloxyalkyl group, a polyalkoxyalkyl group and a polyalkoxyaryl group which all have 4 to 23 carbon atoms. Herein, all R¹ to R′^{p+1} are not simultaneously a hydrogen atom in each of the general formulas (8), (9) and (10). X in the phophite-based stabilizer represented by the general formula (9) denotes a group selected from the group consisting of an aliphatic chain, an aliphatic chain having an aromatic nucleus on its side chain, an aliphatic chain having an aromatic nucleus in its chain, and a chain containing oxygen atoms not including two or more continuously bonded oxygen atoms in the chain. Reference characters k and q are an integer of 1 or more and reference character p is an integer of 3 or more.

The values of k and q of these phosphite-based stabilizers are preferably 1 to 10. The values of k and q of not less than 1 lessen the volatility on heating and those of not more than 10 improve the compatibility with cellulose acetate propionates, which is preferable. The value of p is preferably 3 to 10. The value of p of not less than 3 lessens the volatility on heating and that of not more than 10 improves the compatibility with cellulose acetate propionates, which is preferable.

As specific examples of the phosphite-based stabilizer represented by the following general formula (11) (same as the general formula (8)), those represented by the below chemical formulas (2) to (5) are preferable.

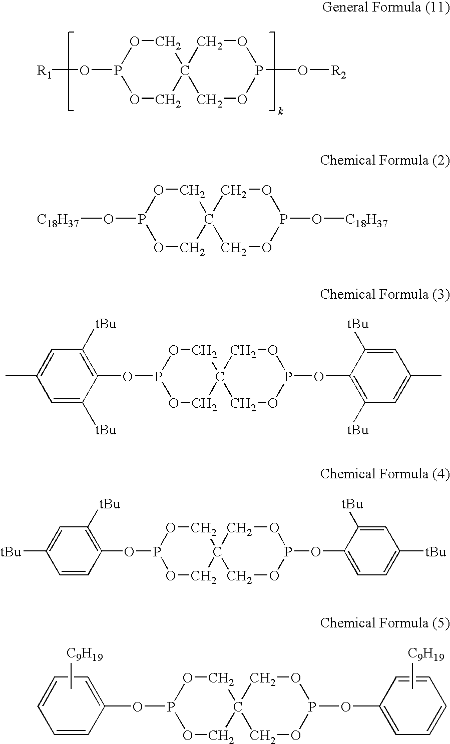

As specific examples of the phosphite-based stabilizer represented by the following general formula (12) (same as the general formula (9)), those represented by the below chemical formulas (6), (7) and (8) are preferable.

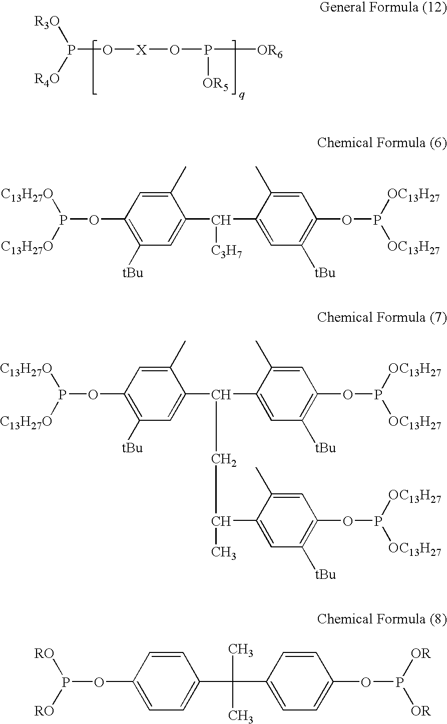

(R=alkyl group with 12 to 15 carbon atoms)

### (ii) Phosphorous Acid Ester Stabilizers

The phosphorous acid ester stabilizers include, for example, cyclic neopentanetetrayl bis(octadecyl)phosphite, cyclic neopentanetetrayl bis(2,4-di-tert-buthylphenyl)phosphite, cyclic neopentanetetrayl bis(2,6-di-tert-butyl-4-methylphenyl)phosphite, 2,2-methylene bis(4,6-di-tert-butylphenyl)octylphosphite and tris(2,4-di-tert-butylphenyl)phosphite.

(iii) Other Stabilizers

Besides, weak organic acids, thioether compounds, epoxy compounds and the like may also be formulated as stabilizers.

The weak acids are those having pKa of not less than 1, and are not especially limited as long as they do not interfere with the action of the present invention and have coloring preventiveness and physical properties-deterioration preventiveness. They include, for example, tartaric acid, citric acid, malic acid, fumaric acid, oxalic acid, succinic acid and maleic acid. These may be used singly or concurrently in two or more.

The thioether compounds include, for example, dilauryl thiodipropionate, ditridecyl thiodipropionate, dimyristyl thiodipropionate, distearyl thiodipropionate and palmityl stearyl thiodipropionate, and these may be used singly or concurrently in two or more.

The epoxy compounds include, for example, compounds derived from epichlorohydrin and bisphenol A, and also derivatives from epichlorohydrin and glycerol, and cyclics such as vinylcyclohexene dioxides and 3,4-epoxy-6-methylcyclohexylmethyl-3,4-epoxy-6-methylcyclohexanecarboxylate. Epoxidized soybean oils, epoxidized castor oils and long chain-α-olefin oxides can also be used. These may be used singly or concurrently in two or more.

### (3) Matting Agents

Microparticles are preferably added as a matting agent. Microparticles used in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate.

These microparticles generally forms a secondary particle of 0.1 to 3.0 μm in average particle size, exist as aggregates of primary particles in films, and forms irregularities of 0.1 to 3.0 μm on the surface of films. The average secondary particle size is preferably 0.2 μm to 1.5 μm, more preferably 0.4 μm to 1.2 μm, most preferably 0.6 μm to 1.1 μm. The particles in films are observed for primary and secondary particle sizes by a scanning electron microscope, and the diameter of a circle circumscribing particles is defined as a particle size. 200 particles on different places are observed, and the average value is defined as an average particle size.

The preferable addition amount of the microparticles is 1 ppm to 500 ppm to a cycloolefin resin in terms of mass, more preferably 5 ppm to 1,000 ppm, still more preferably 10 ppm to 500 ppm.

Microparticles containing silicon are preferable because they can reduce the turbidity, and silicon dioxide is particularly preferable. Microparticles of silicon dioxide preferably have an average primary particle size of not more than 20 nm and an apparent specific gravity of not less than 70 g/l. Microparticles having primary particles having a small average diameter of 5 to 16 nm are more preferable because they can reduce the haze of films. The apparent specific gravity is preferably 90 to 200 g/l or more, more preferably 100 to 200 g/l or more. A larger apparent specific gravity thereof enables to prepare a higher-concentration dispersion, preferably improving the haze and the aggregates.

Usable microparticles of silicon dioxide are, for example, commercially-available ones such as AEROSIL R972, R972V, R974, R812, 200, 200V and 300, R202, OX50 and TT600 (manufactured by Japan Aerosil Co., Ltd.). Microparticles of zirconium oxide are commercially available and usable with trade names of, for example, AEROSIL R976 and R811 (manufactured by Japan Aerosil Co., Ltd.).

Among these, since AEROSIL 200V and AEROSIL R972V are silicon dioxide microparticles having an average primary particle size of not more than 20 nm and an apparent specific gravity of not less than 70 g/l, these AEROSILs are particularly preferable because these have an effect of reducing the friction coefficient of optical films while maintaining the turbidity thereof at a low level.

### (4) Other Additives

As other additives, an infrared absorbing dye, an optical adjusting agent and a surfactant can be added. Materials as these additives described in detail on pages 17 to 22 in Japan Institute of Invention and Innovation Journal of Technical Disclosure No. 2001-1745 (issued on Mar. 15, 2001, Japan Institute of Invention and Innovation) are preferably used.

Usable infrared absorbing agents are those, for example, in Japanese Patent Application Laid-Open No. 2001-194522. Usable ultraviolet absorbents are those described, for example, in Japanese Patent Application Laid-Open No. 2001-151901. Each is preferably contained in 0.001 to 5% by mass to a saturated norbornene resin.

The optical adjusting agents include retardation adjusting agents, and usable ones are described, for example, in Japanese Patent Application Laid-Open Nos. 2001-166144, 2003-344655, 2003-248117 and 2003-66230. Thereby, the in-plane retardation (Re) and the thickness-direction retardation (Rth) can be controlled. The preferable addition amount is 0 to 10% by mass to a saturated norbornene resin, more preferably 0 to 8% by mass, still more preferably 0 to 6% by mass.

Usable ultraviolet absorbents are benzophenone ultraviolet absorbents, benzotriazole ultraviolet absorbents, acrylnitrile ultraviolet absorbents and the like, and among them, benzophenone ultraviolet absorbents are preferable and the addition amount thereof is commonly 10 to 100,000 ppm, preferably 100 to 10,000 ppm.

### <Film Forming>

### (1) Pelletizing

The thermoplastic resin and the additives are preferably mixed and palletized prior to the melt film-forming.

The thermoplastic resin and the additives are preferably dried previously for the pelletization, but use of a vent-type extruder can substitute for the drying. The drying can use a method of heating at 90° C. for 8 or more hours in a heating furnace, but the method is not limited thereto. Pellets can be fabricated by melting the thermoplastic resin and the additives in a twin screw kneading extruder at 150° C. to 280° C. and then solidifying the extruded noodle-like melt in water and cutting the solidified noodle. Pelletization can also be performed by the underwater cutting method, in which the solidified noodle is cut while being directly extruded from an orifice of an extruder into water after melting by the extruder, or other methods.

As long as an extruder provides sufficient melting and kneading, any well-known single screw extruder, a nonintermeshing counter-rotating twin screw extruder, an intermeshing counter-rotating twin screw extruder, an intermeshing co-rotating twin screw extruder and the like can be used.

The preferable size of pellets is 1 mm² to 300 mm² in sectional area and 1 mm to 30 mm in length, more preferably 2 mm² to 100 mm² in sectional area and 1.5 mm to 10 mm in length.

On pelletization, the above-mentioned additives can be charged from a feedstock charging port or a vent mouth on the way of an extruder.

The rotation frequency of an extruder is preferably 10 rpm to 1,000 rpm, more preferably 20 rpm to 700 rpm, still more preferably 30 rpm to 500 rpm. The rotation speed lower than this elongates residence time, decreases the molecular weight due to heat degradation, and easily deteriorates yellowishness, which is therefore unpreferable. Too high a rotation speed easily causes problems such as reducing the molecular weight due to easy cleavage of molecules due to shearing, and increasing generation of crosslinked gel.

The extrusion residence time on pelletization is not less than 10 sec and not more than 30 min, more preferably 15 sec to 10 min, still more preferably 30 sec to 3 min. The shorter residence time, as long as sufficient melting is carried out, is preferable from the view point of enabling to suppress resin deterioration and yellowishness generation.

### (2) Drying

Moisture in pellets is preferably reduced prior to the melt film-forming. Drying methods often involve drying performed using a dehumidified air drier, but are not especially limited as long as a target moisture content can be obtained (Drying is preferably performed effectively by using a method such as heating, air blowing, pressure reduction and stirring singly or in combination thereof. More preferably, a drying hopper has a heat insulating structure.). The drying temperature is preferably 0 to 200° C., more preferably 40 to 180° C., particularly preferably 60 to 150° C. Too low a drying temperature not only takes a long time for drying, but also brings about a moisture content of more than a target value, which are unpreferable. By contrast, too high a drying temperature unpreferably brings about the sticking and blocking of the resin. The amount of drying air is preferably 20 to 400 m³/h, more preferably 50 to 300 m³/h, particularly preferably 100 to 250 m³/h. A small drying air amount unpreferably worsens the drying efficiency. By contrast, a larger drying air amount than a certain amount gives little of a further improvement in the drying effect, and is not economical. The dew point of the air is preferably 0 to −60° C., more preferably −10 to −50° C., particularly preferably −20 to −40° C. At least 15 min of drying time is needed, more preferably at least 1 hour, particularly preferably 2 hours. By contrast, drying for more than 50 hours gives only a small effect on further reducing moisture content, and needlessly elongating the drying time is unpreferable because of concern about thermal degradation of the resin. The thermoplastic resin of the present invention preferably has a moisture content of not more than 1.0% by mass, more preferably not more than 0.1% by mass, particularly preferably not more than 0.01% by mass.

### (3) Melt Extrusion

The cycloolefin resin described above is fed into a cylinder of an extruder through a supply port thereof. The interior of the cylinder is constituted of, in order from the supply port side, a supply unit (region A) to quantitatively feed the thermoplastic resin fed from the supply port, a compression unit (region B) to melt, knead and compress the thermoplastic resin, and a metering unit (region C) to meter the thermoplastic resin which has been molten, kneaded and compressed. The resin is preferably dried by the method described above for reducing the moisture content, but more preferably dried in an inert gas (nitrogen, etc.) flow inside the extruder or while the interior of the extruder is being vacuum evacuated using an extruder with a vent for preventing oxidation of the molten resin due to residual oxygen. The screw compression ratio of the extruder is set at 2.5 to 4.5 and the L/D thereof is set at 20 to 70. Here, the screw compression ratio is expressed in terms of volume ratio of the supply unit A to the metering unit C, i.e. a volume per unit length of the supply unit A divided by a volume per unit length of the metering unit C, and is calculated using an outer diameter d1 of the screw shaft of the supply unit A, an outer diameter d2 of the screw shaft of the metering unit C, a groove diameter a1 of the supply unit A and a groove diameter a2 of the metering unit C. The L/D refers to the ratio of a cylinder inner diameter to a cylinder length. The extruding temperature is set at 200 to 300° C. The temperature in the extruder may be wholly the same, or may have a distribution. More preferably, the temperature of the supply unit is made higher than that of the compression unit.

Too small a screw compression ratio of less than 2.5 leads to insufficient kneading, generates undissolved parts and easily leaves undissolved foreign matters in the thermoplastic film after production, and further, easily results in entrainment of bubbles. Thereby, the strength of the thermoplastic film decreases and when the film is stretched, the film easily ruptures and the orientation cannot be sufficiently enhanced. By contrast, too large a screw compression ratio of more than 4.5 easily deteriorates the resin by heat generation due to too large a shearing stress imparted, bringing about yellowing in the thermoplastic film after production. Too large a shearing stress imparted causes the molecular scission and reduces the molecular weight, reducing the mechanical strength of the film. Therefore, for hardly exhibiting yellowing in the thermoplastic film after production and raising the film strength and hardly causing stretching rupture, the screw compression ratio is preferably in the range of 2.5 to 4.5, more preferably 2.8 to 4.2, particularly preferably 3.0 to 4.0.

Too small an L/D of less than 20 leads to insufficient melting and insufficient kneading, easily generating undissolved foreign matters in the thermoplastic film after production as in the case of the small compression ratio. By contrast, too large an L/D exceeding 70 brings about too long a residence time of the thermoplastic resin in the extruder, easily causing deterioration of the resin. A long residence time causes molecular scission and reduces the molecular weight, reducing the mechanical strength of the thermoplastic resin. Therefore, for hardly exhibiting yellowing in the thermoplastic film after production and raising the film strength and hardly causing stretching rupture, the L/D is preferably in the range of 20 to 70, more preferably 22 to 65, particularly preferably 24 to 50.

The cycloolefin film thus obtained has characteristic values of a haze of not more than 2.0% and a yellow index (YI value) of not more than 10.

As types of extruders, single screw extruders, which generally have a relatively inexpensive facility cost, are often used, and include screw types such as full-flight, Maddock and dulmage, preferably full-flight type for cycloolefin resins. By altering the screw segment although the facility cost becomes high, a twin screw extruder installed on the way with a vent port and enabling extrusion while volatilizing unnecessary volatile components can be used. Twin screw extruders are largely classified into types of co-rotation and counter rotation and either of them can be used, but the co-rotation type, which hardly causes residence parts and has a high self-cleaning performance, is preferable. By suitably arranging a vent port, cycloolefin pellets and powder in undried state can also be used as they are. Further, trimmings and the like of the film produced on the way of film forming can also be recycled without being dried.

The preferable diameter of the screw is, depending on a target extrusion amount per unit time, 10 mm to 300 mm, more preferably 20 mm to 250 mm, still more preferably 30 mm to 150 mm.

### (4) Filtration

Filtration of the so-called breaker plate type, in which a filter medium is installed at an extruder outlet, is preferably performed for filtering foreign matters in the resin and avoiding gear pump damage due to the foreign matters. These purposes can be achieved by adjustment of the bore diameter of the filter medium and the flowing rate of a molten resin as described above.

For filtration of foreign matters with higher precision, a filtering apparatus in which a so-called leaf disk filter is incorporated is preferably installed after passing through the gear pump. Filtration may be performed by installing a filtering section at one place or by a multistage filtration in which a plurality of filtering sections are installed. Although it is preferable that a filter medium have a higher filtration precision, the filtration precision is preferably 15 μm to 3 μm in view of the pressure resistance of the filter medium and a rise of the filtering pressure due to the clogging of the filter medium, more preferably 10 μm to 3 μm. Particularly, in the case of using a leaf disk filter apparatus to finally filter foreign matters, use of a filter medium having a high filtration precision in view of the quality is preferable and the filtration precision can be adjusted by the number of filtering sheets to be loaded for securing the aptitude with the pressure resistance and the filter life. With respect to the kind of a filter medium, iron and steel materials are preferably used in view of its use under a high temperature and high pressure, and among iron and steel materials, especially a stainless steel, steel or the like is preferably used, and especially a stainless steel is desirably used in view of corrosion. With respect to the constitution of a filter medium, in addition to a filter medium obtained by knitting wire rods, for example, a sintered filter medium formed by sintering metallic filaments or a metallic powder can be used, and the sintered filter medium is preferable in view of the filtration precision and the filter life.

### (5) Gear Pump

Reducing the variation in the discharging amount is important for improving the precision in thickness, and the installation of a gear pump between an extruder and a die and the feeding of a saturated norbornene resin of a certain amount from the gear pump have an effect. The gear pump refers to a pump in which a pair of gears composed of a drive gear and a driven gear is intermeshingly housed in a housing, and by intermeshingly rotating both the gears by driving the drive gear, a melting resin is sucked from a suction port formed on the housing into a cavity and the resin is discharged in a certain amount from a discharge port formed on the housing. Even if there is a slight variation in the resin pressure at the end portion of the extruder, use of a gear pump absorbs the variation and the variation in the resin pressure downstream of the film forming apparatus becomes very small, improving the variation in thickness. Use of a gear pump allows the variation width of the resin pressure at a die portion of within ±1%.

For improving the fixed-amount feeding performance by a gear pump, a method can also be used in which the pressure before the gear pump is controlled to be constant by varying the rotation frequency of the screw. Further, a high-precision gear pump using three or more gears in which the variation of the gears has been eliminated is also effective.

Other advantages of using a gear pump, since film forming can be performed with the pressure at the tip end of the screw reduced, lie in expectations of reduction of the energy consumption, prevention of a rise in the resin temperature, improvement of the transport efficiency, reduction of the residence time and reduction of the L/D of the extruder. In the case of using a filter for removing foreign matters, with no gear pump, the resin amount fed from the screw sometimes varies along with the rising filtration pressure, but with a gear pump used in combination, the variation can be eliminated. By contrast, demerits of the gear pump lie in that depending on a selection method the length of the facility becomes long and the residence time of the resin becomes long, and that cleavage of molecular chains is sometimes caused due to a shearing force of the gear pump portion, which should be noticed.

A preferable residence time of a resin from when the resin enters an extruder from the supply port till when the resin goes out a die is 2 min to 60 min, more preferably 3 min to 40 min, still more preferably 4 min to 30 min.

Since there arises a problem that the sealing by a polymer of the drive portion and the bearing portion is degraded due to worsened flow of the polymer for the bearing circulation of a gear pump and the variation in the metering and resin-extruding pressure becomes large, the design (especially of clearance) of the gear pump matched to the melt viscosity of a thermoplastic resin is needed. In some cases, since the residence part of a gear pump causes degradation of a thermoplastic resin, a structure of as little residence as possible is preferable. A polymer pipe or an adaptor connecting an extruder and a gear pump, a gear pump and a die, or the like necessitates a design giving as little residence as possible; and for stabilizing the extruding pressure of a thermoplastic resin having a high dependence on temperature of the melt viscosity, the variation in temperature is preferably as small as possible. A band heater, low in the facility cost, is generally often used for heating a polymer pipe, but an aluminum-cast heater, having a less temperature variation, is more preferably used. Further, melting by heating the barrel of the extruder by a heater divided into three to twenty heaters in the extruder as described above is preferable.

### (6) Die

A thermoplastic resin is molten by an extruder constituted as described before, and, as required, passes through a filtering machine and a gear pump, and the molten resin is continuously transported to a die. As a die, any of a commonly used T-die, fish tail die and hanger coat die can be used as long as the die is designed such that the residence inside the die is little. A static mixer for enhancing uniformity of the resin temperature can problemlessly be inserted right before the T-die. The clearance of a T-die outlet is commonly 1.0 to 5.0 times the film thickness, preferably 1.2 to 3 times, more preferably 1.3 to 2 times. With the lip clearance 1.0 time smaller than the film thickness, it is difficult to provide a planar and favorable sheet by film forming. By contrast, a large lip clearance exceeding 5.0 times the film thickness is unpreferable because the precision in the sheet thickness decreases. The die is a very important facility to decide the precision in a film thickness; a die which can strictly control the thickness adjustment is preferable. Dies can commonly adjust the thickness at 40 to 50 mm intervals, but the types thereof which can adjust the film thickness at not more than 35 mm intervals are preferable; those at not more than 25 mm intervals are more preferable. For improving uniformity of a formed film, a design in which a temperature unevenness and a flow-rate unevenness in the width direction of a die are as small as possible is important. An automatic thickness adjustment die, which measures a downstream film thickness, calculates the thickness deviation and feeds back the calculated result for the thickness adjustment of a die, is also effective for reduction of the film variation in the long-period continuous production.

Production of films generally uses a single-layer film forming apparatus, whose facility cost is inexpensive, but in some cases, films having structures of two or more kinds can be manufactured using a multilayer film forming apparatus for providing a functional layer as an outer layer. Generally, a functional layer is preferably laminated as a thin layer on a surface layer, but the layer ratio is not especially limited.

### (7) Casting

The molten resin extruded in a sheet-like form from the die under the conditions described above is cooled and solidified on a casting drum to obtain a film.

In the present invention, by using a method such as the electrostatic impression method, air knife method, air chamber method, vacuum nozzle method or touch roll method on the casting drum, the adhesion of the casting drum and the molten and extruded sheet is preferably enhanced, but among these methods, the touch roll method is preferably used.

The touch roll method involves placing a touch roll on the casting drum and shaping the film surface. At this time, the touch roll is not a common high-rigidity one, but is preferably one having elasticity. However, a touch roll in which an elastically deformable member (rubber, etc.) is covered with an extremely thin metal cannot provide a high surface pressure (since the deformation amount of the touch roll is large, resulting in too large a contact area with the cast roll, and a sufficient surface pressure cannot be provided), which is unpreferable. The touch roll of the present invention has a wall thickness of not less than 0.5 mm and not more than 7 mm, more preferably 1.1 to 6 mm, still more preferably 1.5 to 5 mm. The surfaces of the touch roll and the casting roll are preferably a mirror surface, and have an arithmetic average height Ra of not more than 100 nm, preferably not more than 50 mm, still more preferably not more than 25 nm. The preferable surface pressure of the touch roll is not less than 0.1 MPa and not more than 10 MPa, more preferably not less than 0.2 MPa and not more than 7 MPa, still more preferably not less than 0.3 MPa and not more than 5 MPa. The surface pressure described herein refers to a value of a force pressing the touch roll divided by a contact area of a thermoplastic film and the touch roll.

The touch roll is installed on a metal shaft, and a heat medium (liquid) may be passed therebetween; the touch roll includes one in which an elastic body layer is installed between an outer cylinder and the metal shaft, and a heat medium (liquid) is filled between the elastic body layer and the outer cylinder. The temperature of the any touch roll is preferably more than Tg−10° C. and not more than Tg+30° C., more preferably not less than Tg−7° C. and not more than Tg+20° C., still more preferably not less than Tg−5° C. and not more than Tg+10° C. The temperature of the casting roll is preferably in the similar temperature range.

Specific examples of touch rolls to be utilized are touch rolls described in Japanese Patent Application Laid-Open Nos. 11-314263 and 11-235747.

A plurality of casting drums (rolls) are preferably used for gradual cooling (the above-mentioned touch roll is arranged so as to touch the first casting roll of the most upstream side (nearest to the die)). Generally, three cooling rolls are relatively often used, but the number thereof is not limited thereto. The diameter of the roll is preferably 50 mm to 5,000 mm, more preferably 100 mm to 2,000 mm, still more preferably 150 mm to 1,000 mm. The interval between surfaces of a plurality of rolls is preferably 0.3 mm to 300 mm, more preferably 1 mm to 100 mm, still more preferably 3 mm to 30 mm. The line speed of the most upstream side of the cast rolls is preferably not less than 20 m/min and not more than 70 m/min.

### (8) Winding-Up

After the film is peeled off the casting drum, the film is wound up through a nip roll.

The film-forming width is 0.7 m to 5 m, preferably 1 m to 4 m, more preferably 1.3 m to 3 m. The thickness of the unstretched film thus obtained is preferably 20 μm to 250 μm, more preferably 25 μm to 200 μm, still more preferably 30 μm to 180 μm.

Trimming of both edges prior to winding-up is preferable. Any type of trimming cutters such as a rotary cutter, shear blade and knife can be used. Either material of the cutters of carbon steel and stainless steel may be used. Generally, use of a superhard blade or a ceramic blade is preferable because the blade has a long life and generation of chips is suppressed. Parts trimmed off by trimming may be shredded to be recycled again as a feedstock.

One edge or both edges are preferably subjected to thicknessing processing (knurling processing). The height of irregularity by thicknessing processing is preferably 1 μm to 200 μm, more preferably 10 μm to 150 μm, still more preferably 20 μm to 100 μm. The thicknessing processing may involve making convexes on both surfaces or on one surface. The width of the thicknessing processing is preferably 1 mm to 50 mm, more preferably 3 mm to 30 mm, still more preferably 5 mm to 20 mm. The extrusion processing can be performed at room temperature to 300° C.

The film thus formed may be stretched as it is (on-line stretching), or may be once wound up and then again reeled out and stretched (off-line stretching).

When the film is wound up, a lamifilm is also preferably attached to at least one surface thereof from the view point of preventing scratches. The thickness of the lamifilm is preferably 5 μm to 200 μm, more preferably 10 μm to 150 μm, still more preferably 15 μm to 100 μm. The material thereof can be polyethylene, polyester, polypropylene and the like, and is not especially limited thereto.

The preferable winding-up tension is 1 kg/m-width to 50 kg/m-width, more preferably 2 kg/m-width to 40 kg/m-width, still more preferably 3 kg/m-width to 20 kg/m-width. With the winding-up tension of less than 1 kg/m-width, it is difficult to wind up the film uniformly. The winding-up tension exceeding 50 kg/w-width winds up the film too tightly wound up, and not only deteriorates the winding appearance, but also causes waving of the film due to stretching by the creeping phenomenon of parts of lumps on the film, as well as generates the residual birefringence due to the elongation of the film, which is unpreferable. The winding-up tension is detected by a tension control on the way of the line, and the film is preferably wound up while being controlled so as to receive a defined winding-up tension. If there are differences in temperature of the film depending on palaces in the film forming line, since the lengths of the film are slightly different due to thermal expansion in some cases, the stretch ratio between the nip rolls must be adjusted so that the film on the way of the line is not subjected to a tension larger than a specified tension.

The winding-up can be performed in a defined tension by control of the tension control, but more preferably with a suitable winding-up tension tapered corresponding to the winding-up diameter. Generally, the tension is gradually decreased as the winding-up diameter increases, but in some cases, it is preferable that the tension be made larger as the winding-up diameter becomes large.

### <<Stretching Process>>

The melt film-formed cycloolefin film may be transversely and longitudinally stretched, and may further be subjected to the relaxation treatment in combination therewith. These can be carried out for example in the following combination.

1. transverse stretching
2. transverse stretching→relaxation treatment
3. longitudinal stretching→transverse stretching
4. longitudinal stretching→transverse stretching→relaxation treatment
5. longitudinal stretching→relaxation treatment→transverse stretching→relaxation treatment
6. transverse stretching→longitudinal stretching→relaxation treatment
7. transverse stretching→relaxation treatment→longitudinal stretching→relaxation treatment
8. longitudinal stretching→transverse stretching→longitudinal stretching
9. longitudinal stretching→transverse stretching→longitudinal stretching→relaxation treatment
10. longitudinal stretching
11. longitudinal stretching→relaxation treatment

Among these, more preferable are 1 to 4 and 10 and 11; still more preferable are 2, 4 and 11. Among these, more preferable are 1 to 4; still more preferable are 2 and 4.

Performing the stretching of the present invention described below can effectively reduce tailing streaks of the present invention and also improve the rupture elongation. When a film becomes thin in stretching, the thickness of tailing parts decreases and the number thereof decreases, but in a common stretching method, the stretching stress is liable to concentrate on weak parts, and tailing parts, whose thickness is slightly thicker, are hardly stretched. By contrast, since the stretching method of the present invention can apply a uniform in-plane stretching stress, tailing parts as well as regular parts are similarly stretched, whereby tailing trouble can be effectively reduced. Additionally, such a uniform stretching can effectively stretch molecules curling in a film and consequently can form intermolecular entanglement, thus providing also an effect of improving rupture elongation.

### (Longitudinal Stretching)

In the present invention, transverse stretching and longitudinal stretching can be preferably performed in combination thereof. In this case, the transverse stretching is more preferably performed after the longitudinal stretching.

Longitudinal stretching can be achieved by installing two pairs of nip rolls and making the periphery speed of the outlet-side nip rolls higher than that of the inlet-side nip rolls while heating between the pairs. At this time, the development of the thickness-direction retardation can be varied by altering the interval (L) between the pairs of nip rolls and the film width (W) before stretching. The L/W (referred to as a length/width ratio) exceeding 2 and not more than 50 (long span stretching) can make Rth small; and the length/width ratio of not less than 0.01 and not more than 0.3 (short span stretching) can make Rth large. In the present invention, any of the long span stretching, short span stretching and a region therebetween (intermediate stretching=L/W exceeding 0.3 and not more than 2) may be used, but the long span stretching and the short span stretching, which can make the orientation angle small, are preferable. Further, in the case of aiming at a higher Rth, the short span stretching is more preferably used; and in the case of aiming at a lower Rth, separately the long span stretching is more preferably used.

### (1-1) Long Span Stretching

A film is stretched with stretching while the film reduces its thickness and width to make its volume change small. At this time, the contraction in the width direction is restricted by the friction between the nip rolls and the film. Therefore, making the nip roll interval large makes width-direction contraction easy and can suppress the thickness reduction. A large thickness reduction has the same effect as compression in the thickness direction of the film, and progresses molecular orientation in the film plane and is liable to raise Rth. A large length/width ratio and a small thickness reduction hardly develop Rth by contrast, and can achieve a low Rth.

Further, a large length/width ratio can improve the uniformity in the width direction. This is due to the following reason.

A film tends to contract in the width direction with longitudinal stretching. The central part in the width direction cannot freely contract because it is placed in a pulling state due to that both edges each tending to contract in the width direction.

On the other hand, an edge part in the width direction of a film is placed in a pulling state with the edge side only, so the film edge part can freely contract.

This difference in contraction behavior involved in stretching between both the edge parts and the central part makes stretching unevenness.

Due to such a nonuniformity between both the edge parts and the central part, the width-direction retardation and the axial deviation (orientation angle distribution of slow axis) are generated. By contrast, in the long span stretching, since a film is slowly stretched between the pairs of nip rolls, uniformization of such nonuniformities (molecular orientation is uniformized) progresses. By contrast, in common longitudinal stretching (length/width ratio exceeding 0.3 and less than 2), such a uniformity is not generated.

The length/width ratio is preferably more than 2 and not more than 50, more preferably 3 to 40, still more preferably 4 to 20. The preferable stretching temperature is (Tg−5° C.) to (Tg+100° C.), more preferably (Tg) to (Tg+50° C.), still more preferably (Tg+5° C.) to (Tg+30° C.). The preferable stretching magnification is 1.05 to 3 times, more preferably 1.05 to 1.7, still more preferably 1.05 to 1.4. Such a long span stretching may be achieved with a multi-stage stretching of three or more pairs of nip rolls as long as the largest length/width ratio of the multi-stage is in the above range.

Such a long span stretching is performed by heating a film between two pairs of nip rolls separated with a predetermined distance. The heating method may be heater heating methods (wherein infrared heaters, halogen heaters, panel heaters or the like are installed above and under a film to heat the film by radiant heat), or zone heating methods (wherein a film is heated in a zone where hot air is blown in to control the temperature at a predetermined one). In the present invention, the zone heating methods are preferable in view of the uniformity of the stretching temperature. At this time, the nip rolls may be installed inside the stretching zone or outside the zone, but the installation outside the zone is preferable for preventing adhesion of a film and the nip rolls. Preheating the film before such a stretching is preferable and the preheating temperature is not less than Tg−80° C. and not more than Tg+100° C.

According to such a stretching, the Re value is 0 to 200 nm, more preferably 10 to 200 nm, still more preferably 15 nm to 100 nm; the Rth value is 30 to 500 nm, more preferably 50 to 400 nm, still more preferably 70 to 350 nm. According to this stretching method, the ratio of Rth and Re (Rth/Re) can be made to be 0.4 to 0.6, more preferably 0.45 to 0.55. Films having such characteristics can be used as an A-plate type retardation plate. Further, according to this stretching, each of the dispersions in the Re value and the Rth value can be made to be not more than 5%, more preferably not more than 4%, still more preferably not more than 3%.

According to such a stretching, the ratio of film widths before and after stretching (a film width after stretching/a film width before stretching) is made to be 0.5 to 0.9, more preferably 0.6 to 0.85, still more preferably 0.65 to 0.83.

### (1-2) Short Span Stretching

The longitudinal stretching (short span stretching) is performed with the length/width ratio (L/W) exceeding 0.01 and less than 0.3, more preferably 0.03 to 0.25, still more preferably 0.05 to 0.2. Stretching with a length/width ratio (L/W) in such a range enables the neck-in (contraction in the direction orthogonal to stretching following stretching) to be small. Although the width and the thickness are reduced to make up for the elongation in the stretching direction, in such a short span stretching, the width contraction is suppressed and the thickness reduction preferentially progresses. As a result, the thickness direction becomes like compressed and the orientation in the thickness direction (plane orientation) progresses. Consequently, Rth, which is a measure of the anisotropy in the thickness direction, is liable to increase. On the other hand, the stretching is conventionally generally performed with the length/width ratio (L/W) of about 1 (0.7 to 1.5). This is because in conventional stretching with heating heaters installed between nip rolls, if L/W is too large, a film is hardly uniformly heated by heaters and stretching unevenness is easily generated; if L/W is too small, the installation of heaters is difficult and heating cannot be sufficiently performed.

The above-mentioned short span stretching can be achieved by varying the transportation speeds between two or more pairs of nip rolls, but can be achieved by arranging diagonally two pairs of nip rolls (by deviating front nip rolls and back nip rolls up and down), different from the common roll arrangement. Along with this, a heating heater cannot be installed between nip rolls, so the temperature of a film is preferably raised by making a heat medium flow in the nip rolls. It is also preferable that a preheating rolls inside which a heat medium is made to flow be further installed prior to the inlet-side nip rolls and a film be heated before stretching.

The preferable stretching temperature is (Tg−5° C.) to (Tg+100° C.), more preferably (Tg) to (Tg+50° C.), still more preferably (Tg+5° C.) to (Tg+30° C.). The preferable preheating temperature is not less than Tg−80° C. and not more than Tg+100° C.

### (Transverse Stretching)

The transverse stretching is achieved using a tenter. That is, both end parts in the width direction of a film are held with clips and enlarged in the transverse directions for stretching. At this time, the stretching temperature can be controlled by blowing air of a desired temperature in the tenter. The stretching temperature is preferably not less than Tg−10° C. and not more than Tg+60° C., more preferably not less than Tg−5° C. and not more than Tg+45° C., still more preferably not less than Tg and not more than Tg+30° C.

Performing the preheating before the stretching and the thermal fixation after the stretching can lessen the Re and Rth distributions and the dispersion in orientation angle involved in bowing. Only one of the preheating and the thermal fixation is sufficient, but performing both is more preferable. The preheating and the thermal fixation are preferably performed while the film is being grasped with clips, that is, they are preferably performed continuously with stretching.

The preheating temperature is not less than 1° C. and not more than 50° C. higher than the stretching temperature, more preferably not less than 2° C. and not more than 40° C. higher than that, still more preferably not less than 3° C. and not more than 30° C. higher than that. The preferable preheating time is not less 1 sec than and not more than 10 min, more preferably not less 5 sec than and not more than 4 min, still more preferably not less 10 sec than and not more than 2 min. On the preheating, the width of the tenter is preferably kept nearly a constant. Here, “nearly” means ±10% of the unstretched film width.

The thermal fixation temperature is not less than 1° C. and not more than 50° C. lower than the stretching temperature, more preferably not less than 2° C. and not more than 40° C. lower than that, still more preferably not less than 3° C. and not more than 30° C. higher than that. The preferable preheating time is not less than 1 sec and not more than 10 min, more preferably not less than 5 sec and not more than 4 min, still more preferably not less than 10 sec and not more than 2 min. On the thermal fixation, the width of the tenter is preferably kept nearly a constant. Here, “nearly” means 0% of the tenter width after the finish of stretching (the same width as the tenter width after stretching) to −10% thereof (contracted by 10% from the tenter width after stretching=contracted width). Enlargement in width of more than the stretching width is unpreferably liable to generate the residual strain in the film and increase the variation over time of Re and Rth.

The thermal fixation temperature<the stretching temperature<the preheating temperature is thus preferable.

That such a preheating and a thermal fixation enable the dispersions in orientation angle and Re and Rth to be small comes from the following reason.

A film is stretched in the transverse directions and tends to thicken in the orthogonal direction (longitudinal direction) (neck-in). Therefore, the film before and after the transverse stretching is pulled and generates a stress. However, both edges in the width direction are fixed by chucks, so the edge parts are hardly susceptible to deformation due to the stress, but the central part in the width direction is susceptible to deformation. Consequently, the stress due to neck-in deforms in a bow shape and generates bowing. Thereby, the unevenness in the in-plane Re and Rth and the distribution of the orientation angle are generated.

For suppressing this, if the temperature of the preheating (before stretching) is raised and the temperature of the thermal treatment (after stretching) is lowered, the neck-in is generated at a higher temperature side (preheating), where the elasticity is lower, and is hardly generated at the thermal treatment (after stretching). Consequently, the bowing after stretching can be suppressed.

Such a stretching can further make the dispersions in the width and longitudinal directions of Re and Rth to be each not more than 5%, more preferably not more than 4%, still more preferably not more than 3%. That can further make the orientation angle to be not more than 90°±5°, or not more than 0°±5°, more preferably not more than 90°±3°, or not more than 0°±3°, still more preferably not more than 90°±1°, or not more than 0°±1°.

The present invention has a feature that such an effect can be achieved even in a high speed stretching, and remarkably exhibits the effect preferably at not less than 20 m/min, more preferably at not less than 25 m/min, still more preferably at not less than 30 m/min.

### <<Relaxation Treatment>>

Additionally performing the relaxation treatment after stretching can improve the dimensional stability. The thermal relaxation is preferably performed after the longitudinal stretching or after the transverse stretching, or after the both, and more preferably after the transverse stretching. The relaxation treatment may be performed on-line continuously after the stretching, or off-line after winding-up after the stretching.

The thermal relaxation is preferably performed at not less Tg−30° C. than and not more than Tg+30° C., more preferably not less Tg−30° C. than and not more than Tg+20° C., still more preferably not less Tg−15° C. than and not more than Tg+10° C.; for not less than 1 sec and not more than 10 min, more preferably not less than 5 sec and not more than 4 min, still more preferably not less than 10 sec and not more than 2 min; and at a tension on transportation of not less than 0.1 kg/m and not more than 20 kg/m, more preferably not less than 1 kg/m and not more than 16 kg/m, still more preferably not less than 2 kg/m and not more than 12 kg/m.

### <<Volatile Components During Stretching>>

In the above-mentioned longitudinal stretching and transverse stretching, volatile components (such as solvents and moisture) are preferably not more than 1% by weight to the resin, more preferably not more than 0.5% by weight, still more preferably 0.3% by weight. This enables the axial deviation generated during stretching to be slight. This is because in addition to a contraction stress exerted in the direction orthogonal to the stretching during stretching, a contraction stress involved in drying is exerted and the bowing becomes remarkable.

### <<Physical Properties After Stretching>>

The thermoplastic film thus subjected to longitudinal stretching, transverse stretching or longitudinal and transverse stretching preferably has Re and Rth satisfying the following expressions (R-1) and (R-2), respectively.

Expression (R-1): 0 nm≦Re≦200 nm
Expression (R-2): 0 nm≦Rth≦600 nm
(wherein Re denotes an in-plane retardation of the thermoplastic film; and Rth denotes a thickness-direction retardation thereof.)
More preferably,

### Rth≧Rex 1.1,

### 180≧Re≧10, and

400≧Rth≧50, and still more preferably,

### Rth≧Re×1.2,

### 150≧Re≧20, and

### 300≧Rth≧100

An angle θ made by the film forming direction (longitudinal direction) and a slow axis of Re of the film is preferably as near to 0°, +90° or −90° as possible. That is, in the case of the longitudinal stretching, the angle is preferably as near to 0° as possible and preferably 0±3°, more preferably 0±2°, still more preferably 0±1°. In the case of the transverse stretching, the angle is preferably 90°±1° or −90°±3°, more preferably 90°±2° or −90°±2°, still more preferably 90°±1° or −90°±1°.

The dispersions in Re and Rth are each preferably 0% to 8%, more preferably 0% to 5%, still more preferably 0% to 3%.

The variations under preservation over time in Re and Rth (changes in Re and Rth before and after the elapse of 500 hours at 80° C., details will be described later.) are each preferably not less than 0% and not more than 8%, more preferably not less than 0% and not more than 6%, still more preferably not less than 0% and not more than 4%.

The thermoplastic film after stretching preferably has a thickness of 15 μm to 200 μm, more preferably 20 μm to 120 μm, still more preferably 30 μm to 80 μm. The thickness unevenness in either of the longitudinal direction and the width direction is preferably 0% to 3%, more preferably 0% to 2%, still more preferably 0% to 1%. Use of a thin film hardly remains a residual strain in the film after stretching and hardly generates retardation change over time. This is because when the film is cooled after stretching, if the film is thick, the cooling of the interior of the film is retarded as compared with that of the surface thereof, and a residual strain caused by a difference in thermal contraction amount is liable to generate.

The thermal dimensional changing rate is preferably not less than 0% and not more than 0.5%, more preferably not less than 0% and not more than 0.3%, still more preferably not less than 0% and not more than 0.2%. Here, the thermal dimensional changing rate refers to a dimensional change when a film is thermally treated at 80° C. for 5 hours (details will be described later.).

### <<Processing of the Cycloolefin Film>>

The cycloolefin film of the present invention thus obtained may be used singly, used in combination with a polarization plate, or used with a liquid crystal layer, a layer whose refractive index has been controlled (low reflection layer) or a hard coat layer installed thereon. These can be achieved by the following processes.

### (Surface Treatment)

The glow discharge treatment, ultraviolet irradiation treatment, corona treatment, flame treatment and acid or alkali treatment can be used. The glow discharge treatment mentioned here involves a low-temperature plasma treatment generated in a low-pressure gas of 10⁻³ to 20 Torr (0.13 to 2,700 Pa). The plasma treatment under atmospheric pressure is also a preferable glow discharge treatment.

A plasma excitable gas refers to a gas plasma-excited under the above-mentioned condition, and includes argon, helium, neon, krypton, xenon, nitrogen, carbon dioxide, chlorofluorocarbons such as tetrafluoromethane, and a mixture thereof. These are in detail described on page 30 to page 32 in Japan Institute of Invention and Innovation Journal of Technical Disclosure (No. 2001-1745, issued on Mar. 15, 2001, Japan Institute of Invention and Innovation). The plasma treatment under atmospheric pressure, which has been recently given attention, uses, for example, an irradiation energy of 20 to 500 kGy at 10 to 1,000 keV, more preferably that of 20 to 300 kGy at 30 to 500 keV.

Among these most preferable are the glow discharge treatment, corona treatment and flame treatment.

Providing of an undercoat layer for the adhesion with a functional layer is also preferable. This layer may be applied after the above-mentioned surface treatment, or without the surface treatment. The detail of the undercoat layer is described on page 32 in Japan Institute of Invention and Innovation Journal of Technical Disclosure (No. 2001-1745, issued on Mar. 15, 2001, Japan Institute of Invention and Innovation).

These surface treatment and undercoat process can be incorporated as the final of a film forming process, performed singly, or performed in a functional layer-imparting process described later.

### (Imparting of Functional Layers)

The cycloolefin film of the present invention is preferably combined with functional layers described in detail on page 32 to page 45 in Japan Institute of Invention and Innovation Journal of Technical Disclosure (No. 2001-1745, issued on Mar. 15, 2001, Japan Institute of Invention and Innovation). Among them preferable are imparting of a polarization layer (polarization plate), imparting of an optical compensation layer (optical compensation sheet) and imparting of a reflection preventing layer (reflection preventing film).

### (A) Imparting of a Polarization Layer (Fabrication of a Polarization Plate)

### (A-1) Materials to be Used

At present, commercially available polarization layers are generally fabricated by immersing a stretched polymer in a solution of iodide or a dichroic dye in a bath to infiltrate the iodide or the dichroic dye into the binder. As a polarization film, a coating type polarization film typified by Optiva Inc. can be also utilized. Iodide and a dichroic dye in a polarization film develop the polarization performance by their orientation in a binder. As a dichroic dye, azo dyes, stilbene dyes, pyrazolone dyes, triphenylmethane dyes, quinoline dyes, oxazine dyes, thiazine dyes or anthraquinone dyes are used. The dichroic dyes are preferably water-soluble. The dichroic dyes preferably have a hydrophilic substituent (for example, a sulfo group, an amino group and a hydroxyl group). For example, compounds described on page 58 in Japan Institute of Invention and Innovation Journal of Technical Disclosure (No. 2001-1745, issued on Mar. 15, 2001, Japan Institute of Invention and Innovation) are included.

A binder to be used for the polarization film may be either of a self-crosslinkable polymer and a polymer to be crosslinked with a crosslinking agent, and a plurality of these combinations can be used. The binders include, for example, methacrylate copolymers, styrenic copolymers, polyolefins, polyvinyl alcohols and modified polyvinyl alcohols, poly(N-methylolacrylamide)s, polyesters, polyimides, vinyl acetate copolymers, carboxymethylcelluloses and polycarbonates, which are described in paragraph [0022] in Japanese Patent Application Laid-Open No. 8-338913. Silane coupling agents can be used as a polymer. Water-soluble polymers (for example, poly(N-methylolacrylamide)s, carboxymethylcelluloses, gelatin, polyvinyl alcohols and modified polyvinyl alcohols) are preferable; gelatin, polyvinyl alcohols and modified polyvinyl alcohols are more preferable; and polyvinyl alcohols and modified polyvinyl alcohols are most preferable. Two kinds of polyvinyl alcohols or modified polyvinyl alcohols having different polymerization degrees are especially preferably used. The saponification degree of the polyvinyl alcohol is preferably 70 to 100%, more preferably 80 to 100%. The polymerization degree of the polyvinyl alcohol is preferably 100 to 5,000. The modified polyvinyl alcohols are described in Japanese Patent Application Laid-Open Nos. 8-338913, 9-152509 and 9-316127. The polyvinyl alcohols and the modified polyvinyl alcohols may be used concurrently in two or more kinds.

The lower limit of the binder thickness is preferably 10 μm. The upper limit thereof is preferably as thin as possible in view of light leakage from a liquid crystal display apparatus. The upper-limit thickness is preferably not more than the thickness of polarization plates now commercially available (about 30 μm), preferably not more than 25 μm, more preferably not more than 20 μm.

The binder of a polarization film may be crosslinked. A polymer or monomer having a crosslinkable functional group may be mixed in the binder; or a crosslinkable functional group may be imparted to a binder polymer itself. Crosslinking can be carried out with light, heat or pH change to form a binder having a crosslinked structure. The crosslinking agents are described in the specification of U.S. Reissue Pat. No. 23297. Boron compounds (for example, borate and borax) can also be used as a crosslinking agent. The addition amount of a crosslinking agent of a binder is preferably 0.1 to 20% by mass to the binder. This brings about a favorable orientation of a polarization element and a favorable moisture and thermal resistance of a polarization film.

Even after the finish of the crosslinking reaction, the unreacted crosslinking agent is preferably not more than 1.0% by mass, more preferably not more than 0.5% by mass, thereby improving the weather resistance.

### (A-2) Stretching of a Polarization Layer

A polarization film is preferably obtained by stretching a polarization film (stretching method), or dyeing with iodide or a dichroic dye after rubbing (rubbing method).

In the case of the stretching method, the stretching magnitude is preferably 2.5 to 30.0 times, more preferably 3.0 to 10.0 times. The stretching can be performed by the dry stretching in the air. The stretching can also be performed by the wet stretching in the state of immersing in water. The stretching magnitude of the dry stretching is preferably 2.5 to 5.0 times; that of the wet stretching is preferably 3.0 to 10.0 times. The stretching may be performed parallel with the MD direction (parallel stretching) or in the diagonal direction (diagonal stretching). The stretching may be performed once or by dividing in several times. Dividing in several times enables more uniform stretching even in a high-magnitude stretching.

### a) Parallel Stretching Method

Prior to stretching, PVA film is swollen. The swelling degree is 1.2 to 2.0 times (a weight ratio of before and after swelling). Thereafter, the film is, while being continuously transported through guide rolls, stretched in an aqueous medium bath or a dyeing bath in which a dichroic substance is dissolved, at a bath temperature of 15 to 50° C., particularly 17 to 40° C. The stretching is achieved by grasping the film with two pairs of nip rolls and making the transport speed of the back-stage rolls higher than that of the front-stage rolls. The stretching magnitude, based on a length ratio of after stretching/initial state (same hereafter), is preferably 1.2 to 3.5 times, particularly 1.5 to 3.0 times in view of the above-mentioned effect. Thereafter, the film is dried at 50° C. to 90° C. to obtain a polarization film.

### b) Diagonal Stretching Method

This method can use a stretching method using a tenter diagonally overhanging, described in Japanese Patent Application Laid-Open No. 2002-86554. Since this stretching is performed in the air, it is necessary to make stretching easy by previously hydrating the film. The preferable moisture content is not less than 5% and not more than 100%, more preferably not less than 10% and not more than 100%.

The temperature on stretching is preferably not less than 40° C. and not more than 90° C., more preferably not less than 50° C. and not more than 80° C. The humidity is preferably not less than 50% RH and not more than 100% RH, more preferably not less than 70% RH and not more than 100% RH, still more preferably not less than 80% RH and not more than 100% RH. The advancing speed in the longitudinal direction is preferably not less than 1 m/min, more preferably 3 m/min.

After the finish of the stretching, the film is dried at not less than 50° C. and not more than 100° C., more preferably not less than 60° C. and not more than 90° C., for not less than 0.5 min and not more than 10 min. Not less than 1 min and not more than 5 min are more preferable.

The absorption axis of the polarization film thus obtained is preferably 10° to 80°, more preferably 30° to 60°, still more preferably substantially 45° (40° to 50°).

### (A-3) Lamination

The thermoplastic resin film after the above-mentioned surface treatment and the polarization layer prepared by stretching are laminated to prepare a polarization plate. The laminating direction is preferably made such that the casting axis direction of the thermoplastic resin film and the stretching axis direction of the polarization plate make 45°.

An adhesive for the lamination is not especially limited, but includes PVA resins (including PVAs modified with an acetoacetyl group, sulfonic acid group, carboxyl group, oxyalkylene group or the like) and aqueous solutions of boron compounds, and particularly PVA resins among them are preferable. The thickness of the adhesive after drying is preferably 0.01 to 10 μm, particularly preferably 0.05 to 5 μm.

The light transmittance of the polarization plate thus obtained is preferably as high as possible, and the polarization degree thereof is preferably as high as possible. The transmittance of the polarization plate is preferably in the range of 30 to 50% at light of 550 nm in wavelength, more preferably in the range of 35 to 50%, most preferably in the range of 40 to 50%. The polarization degree thereof is preferably in the range of 90 to 100% at light of 550 nm in wavelength, more preferably in the range of 95 to 100%, most preferably in the range of 99 to 100%.

Further, circularly polarized light can be fabricated by laminating the polarization plate thus obtained with a λ/4 plate. In this case, the lamination is performed such that the slow axis of the λ/4 plate and the absorbing axis of the polarization plate make 45°. At this time, the λ/4 plate is not especially limited, but more preferably one having a wavelength dependence of exhibiting a smaller retardation at a lower wavelength. Additionally, a polarization film having an absorbing axis tilting through 20° to 70° against the longitudinal direction is preferably used; and a λ/4 plate composed of an optically anisotropic layer composed of a liquid crystalline compound is preferably used.

### (B) Imparting of an Optical Compensation Layer (Fabrication of an Optical Compensation Sheet)

An optically anisotropic layer is for compensating for a liquid crystal compound in liquid crystal cells for black display apparatusing of a liquid crystal display apparatus, and is formed by forming an alignment film on a thermoplastic resin film of the present invention and further imparting an optically anisotropic layer.

### (B-1) Alignment Film

An alignment film is provided on a thermoplastic resin film whose surface has been treated as above-mentioned. This film has a function of specifying the alignment direction of liquid crystalline molecules. However, if the alignment state of a liquid crystalline compound is fixed after the liquid crystalline compound has been aligned, since the alignment film serves its function, this process of providing an alignment film is not necessarily essential as the composing element of the present invention. That is, the polarization plate of the present invention can also be fabricated by transferring only an optically anisotropic layer on the alignment film whose alignment state has been fixed, on a polarizer.

The alignment film can be provided by a method such as the rubbing treatment of an organic compound (preferably, a polymer), the oblique deposition of an inorganic compound, the formation of a layer having a micro groove or the build-up of an organic compound (for example, ω-tricosanic acid, dioctadecylmethylammonium chloride and methyl stearate) by the Langmuir-Plodgett method (LB film). Further, alignment films generating the alignment function by imparting of electric field, imparting of magnetic field and light irradiation are also known.

The alignment film is preferably formed by the rubbing treatment of a polymer. The polymer used for the alignment film has, in principle, a molecular structure having a function of aligning liquid crystalline molecules.

In the present invention, in addition to the function of aligning liquid crystalline molecules, it is preferable that a side chain having a crosslinkable functional group (e.g. double bond) be bonded to the main chain, or a crosslinkable functional group having a function to align liquid crystalline molecules be incorporated into the side chain.

As the polymer used for the alignment film, either of a self-crosslinkable polymer and a polymer to be crosslinked with a crosslinking agent can be used, and a plurality of these combinations can be used. Examples of the polymers include methacrylate copolymers, styrenic copolymers, polyolefins, polyvinyl alcohols and modified polyvinyl alcohols, poly(N-methylolacrylamide)s, polyesters, polyimides, vinyl acetate copolymers, carboxymethylcelluloses and polycarbonates, which are described in paragraph [0022] in Japanese Patent Application Laid-Open No. 8-338913. Silane coupling agents can be used as the polymer. Water-soluble polymers (for example, poly(N-methylolacrylamide)s, carboxymethylcelluloses, gelatin, polyvinyl alcohols and modified polyvinyl alcohols) are preferable; gelatin, polyvinyl alcohols and modified polyvinyl alcohols are more preferable; and polyvinyl alcohols and modified polyvinyl alcohols are particularly preferable. Two kinds of polyvinyl alcohols or modified polyvinyl alcohols having different polymerization degrees are most preferably used. The saponification degree of the polyvinyl alcohol is preferably 70 to 100%, more preferably 80 to 100%. The polymerization degree of the polyvinyl alcohol is preferably 100 to 5,000.

Side chains having a function of aligning liquid crystalline molecules generally have a hydrophobic group as a functional group. The specific kind of a functional group is decided according to the kind of liquid crystalline molecule and the alignment state to be needed. For example, modifying groups for a modified polyvinyl alcohol can be incorporated by copolymerization modification, chain transfer modification or block polymerization modification. Examples of modifying groups include hydrophilic groups (a carboxylic acid group, sulfonic acid group, phosphonic acid group, amino group, ammonium group, amide group, thiol group, etc.), hydrocarbon groups having 10 to 100 carbon atoms, hydrocarbon groups substituted with a fluorine atom, a thioether group, polymerizable groups (an unsaturated polymerizable group, epoxy group, aziridinyl group, etc.), alkoxysilyl groups (trialkoxy, dialkoxy, monoalkoxy). Specific examples of these modified polyvinyl alcohol compounds include those described, for example, in paragraphs [0022] to [0145] of Japanese Patent Application Laid-Open No. 2000-155216 and in paragraphs [0018] to [0022] of Japanese Patent Application Laid-Open No. 2002-62426.

If a side chain having a crosslinkable functional group is bonded to the main chain of an alignment film polymer, or a crosslinkable functional group is incorporated to the side chain having a function to align liquid crystalline molecules, the polymer of the alignment film and polyfunctional monomers contained in an optically anisotropic layer can be copolymerized. Consequently, not only a polyfunctional monomer and a polyfunctional monomer, but an alignment film polymer and an alignment film polymer, as well as a polyfunctional monomer and an alignment film polymer are firmly bonded with a covalent bond. Therefore, incorporation of a crosslinkable functional group to an alignment film polymer can remarkably improve the strength of an optical compensation sheet.

The crosslinking functional group of an alignment film polymer preferably contains a polymerizable group as the polyfunctional monomer. Specific examples include those described in paragraphs [0080] to [0100] of Japanese Patent Application Laid-Open No. 2000-155216. The alignment film polymer can be crosslinked using a crosslinking agent, separatedly from the above-mentioned crosslinkable functional group.

The crosslinking agent includes aldehydes, N-methylol compounds, dioxane derivatives, compounds which act by activation of a carboxyl group, active vinyl compounds, active halogene compounds, isoxazol and dialdehyde starch. Two or more crosslinking agents may be concurrently used. Specific examples include compounds described in paragraphs [0023] to [0024] of Japanese Patent Application Laid-Open No. 2002-62426. Aldehydes, which have a high reactive activity, especially glutaraldehyde, are preferable.

The addition amount of a crosslinking agent is preferably 0.1 to 20% by mass to a polymer, more preferably 0.5 to 15% by mass. The amount of an unreacted crosslinking agent remaining in an alignment film is preferably not more than 1.0% by mass, more preferably not more than 0.5% by mass. Such a control allows a sufficient durability generating no reticulation even if the alignment film is used for a long time for a liquid crystal display apparatus and is left for a long time under a high-temperature and high-humidity atmosphere. The alignment film can be formed basically by applying the above-mentioned polymer containing a crosslinking agent, which is an alignment film forming material, on a transparent supporter, and then heating for drying (crosslinking) the applied material and subjecting the heated material to rubbing treatment. The crosslinking reaction may be performed at any period after the application on the transparent supporter as described above. In the case where a water-soluble polymer like a polyvinyl alcohol is used as an alignment film forming material, the applying liquid is preferably a mixed solvent of an organic solvent having a defoaming function (e.g. methanol) and water. The mixing ratio by mass of water:methanol is preferably 0:100 to 99:1, more preferably 0:100 to 91:9. Thereby, generation of bubbles is suppressed and defects of an alignment film and further the layer surface of an optically anisotropic layer are remarkably reduced.

As an applying method of an alignment film, the spin coating, dip coating, curtain coating, extrusion coating, rod coating or roll coating is preferable. Especially the rod coating method is preferable. The thickness after drying is preferably 0.1 to 10 μm. The heat drying can be performed at 20° C. to 110° C. For forming a sufficient crosslinking, it is preferably 60° C. to 100° C., particularly preferably 80° C. to 100° C. The drying time can be 1 min to 36 hours, preferably 1 min to 30 min. The pH is preferably set at an optimum value for a crosslinking agent to be used; in the case of using glutaraldehyde, pH is preferably 4.5 to 5.5, particularly preferably 5.0.

The alignment film is provided on a transparent supporter or the above-mentioned undercoat layer. The alignment film can be obtained by crosslinking a polymer layer as described above, and then subjecting its surface to rubbing treatment.

A treatment method broadly adopted as a liquid crystal alignment process of LCDs can be applied to the above rubbing treatment. That is, the method is one in which the surface of an alignment film is rubbed in a certain direction using paper, gauze, felt, rubber, nylon, polyester fibers or the like to obtain the alignment. Generally, the alignment is performed by rubbing several times using a fabric on which fibers uniform in length and thickness are evenly transplanted or other materials.

In the industrial alignment, the alignment is achieved by bringing a rotating rubbing roll into contact against a film being transported with a polarization layer attached, and the circularity, cylindricity and fluctuation (eccentricity) of the rubbing roll are each preferably not more than 30 μm. The lapping angle of the film on the rubbing roll is preferably 0.1° to 90°. Herein, a stable rubbing treatment can also be provided by winding the film by not less than 360° as described in Japanese Patent Application Laid-Open No. 8-160430. The transportation speed of a film is preferably 1 to 100 m/min. A suitable rubbing angle is preferably selected in the range of 0 to 60°. In the case of using the film for liquid crystal display apparatuses, the angle is preferably 40 to 50°, particularly preferably 45°.

The thickness of the alignment film thus obtained is preferably in the range of 0.1 to 10 μm.

Then, liquid crystalline molecules in an optically anisotropic layer are aligned on the alignment film. Thereafter, as required, the alignment film polymer and polyfunctional monomers contained in the optically anisotropic layer are allowed to react, or the alignment film polymer is crosslinked with a crosslinking agent.

Liquid crystalline molecules used in the optically anisotropic layer include a rod-shaped liquid crystalline molecule and a disc-shaped liquid crystalline molecule. The rod-shaped liquid crystalline molecule and the disc-shaped liquid crystalline molecule may be a polymeric liquid crystal or a low molecular liquid crystal, and further include also a low molecular liquid crystal which has been crosslinked and exhibits no crystallinity.

### (B-2) Rod-Shaped Liquid Crystalline Molecules

As a rod-shaped liquid crystalline molecule preferably used are azomethines, azoxys, cyanobiphenyls, cyanophenyl esters, benzoates, cyclohexanecarboxylic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles.

Rod-shaped liquid crystalline molecules include metal complexes as well. Further, liquid crystal polymers containing a rod-shaped liquid crystalline molecule in their repeating unit are also used as a rod-shaped liquid crystalline molecule. In other words, a rod-shaped liquid crystalline molecule may be bonded to a (liquid crystal) polymer.

Rod-shaped liquid crystalline molecules are described in chapters 4, 7 and 11 of Quarterly chemical Review Vol. 22 “Chemistry of Liquid Crystal” (1994), edited by the Chemical Society of Japan, and in chapter 3 of Liquid Crystal Device Handbook, edited by The Japan Society of the Promotion of Science, No. 142 committee.

The birefractive index of the rod-shaped liquid crystalline molecule is preferably in the range of 0.001 to 0.7.

The rod-shaped liquid crystalline molecule preferably has a polymerizable group for fixing its alignment state. The polymerizable group is preferably a radical polymerizable unsaturated group or a cationic polymerizable group, and specifically includes, for example, polymerizable groups and polymerizable liquid crystal compounds described in paragraphs [0064] to [0086] of Japanese Patent Application Laid-Open No. 2002-62427.

### (B-3) Disc-Shaped Liquid Crystalline Molecules

Disc-shaped (discotic) liquid crystalline molecules include benzene derivatives described in a research report of C. Destrade et al., Mol. Cryst., Vol. 71, p. 111 (1981); truxene derivatives described in research reports of C. Destrade et al., Mol. Cryst., Vol. 122, p. 141 (1985) and Physics lett, A, Vol. 78, p. 82 (1990); cyclohexane derivatives described in a research report of Kohne et al., Angew. Chem., Vol. 96, p. 70 (1984); and azacrown and phenylacetylene macrocycles described in a research report of J. M. Lehn et al., J. Chem. Commun., p. 1794 (1985) and a research report of J. Zhang et al., J. Am. Chem. Soc., Vol. 116, p. 2655 (1994).

Disc-shaped liquid crystalline molecules also include compounds exhibiting the crystallinity and having a structure in which a linear alkyl group, alkoxy group or substituted benzoyloxy group is radially substituted as a side chain of a mother nucleus at the molecular center. A molecule or an assembly of a molecule is preferably a compound having a rotary symmetry and capable of imparting a defined alignment. For an optically anisotropic layer formed of a disc-shaped liquid crystalline molecule, a compound finally contained in the optically anisotropic layer is not necessarily a disc-shaped liquid crystalline molecule, and also includes, for example, a compound formed by polymerization or crosslinking of a low molecular disc-shaped liquid crystalline molecule which has a reactive group to react by heat or light, and is eventually polymerized and crosslinked by heat or light and is macromolecularized and loses liquid crystallinity. A preferable example of a disc-shaped liquid crystalline molecule is described in Japanese Patent Application Laid-Open No. 8-50206. The polymerization of a disc-shaped liquid crystalline molecule is described in Japanese Patent Application Laid-Open No. 8-27284.

For fixing a disc-shaped liquid crystalline molecule by polymerization, a polymerizable group as a substituent must be bonded to the disc-shaped core of the disc-shaped liquid crystalline molecule. A compound obtained by bonding a disc-shaped core and a polymerizable group through a linking group is preferable, thereby enabling to hold the alignment state in the polymerization reaction. The compound includes, for example, a compound described in paragraphs [0151] to [0168] of Japanese Patent Application Laid-Open No. 2000-155216.

In a hybrid alignment, the angle made by the major axis (disc plane) of a disc-shaped liquid crystalline molecule and the plane of a polarization film increases or decreases with the increasing distance from the polarization film in the depth direction of an optically anisotropic layer. The angle preferably decreases with the increasing distance. Further, the variation in the angle can be a continuous increase, a continuous decrease, an intermittent increase, an intermittent decrease, a variation containing a continuous increase and a continuous decrease, or an intermittent variation containing an increase and a decrease. The intermittent variation includes a region where the tilt angle does not vary on the way in the thickness direction. The angle is allowed to include a region where the angle does not vary as long as the angle increases or decreases as a whole. Additionally, the angle is preferably varied continuously.

The average direction of the major axis of a disc-shaped liquid crystalline molecule on a polarization film side can be generally controlled by selecting a material of the disc-shaped liquid crystalline molecule or the polarization film, or by selecting a rubbing treatment method. The major axis (disc plane) direction of a disc-shaped liquid crystalline molecule on the surface side (the air side) can be generally controlled by selecting a kind of additive used together with the disc-shaped liquid crystalline molecule. The additive used together with the disc-shaped liquid crystalline molecule includes, for example, plasticizers, surfactants, polymerizable monomers and polymers. The degree of the variation in the alignment direction of the major axis can also be controlled by selecting a liquid crystalline molecule and an additive.

### (B-4) Other Compositions of the Optically Anisotropic Layer

Concurrent use of a plasticizer, a surfactant, a polymerizable monomer and the like with the above liquid crystalline molecule can improve the uniformity of a coated film, the strength of the film, the alignability of liquid crystal molecules and the like. These substances are preferably ones which have a compatibility with the liquid crystal molecules and can vary the tilt angle of the liquid crystal molecules or does not inhibit the alignment thereof.

Polymerizable monomers include radically polymerizable or cationically polymerizable compounds. Polyfunctional radically polymerizable monomers are preferable, and those copolymerizable with a liquid crystal compound containing the above-mentioned polymerizable group. The polymerizable monomers include, for example, those described in paragraphs [0018] to [0020] of Japanese Patent Application Laid-Open No. 2002-296423. The addition amount of the above compound is generally in the range of 1 to 50% by mass to a disc-shaped liquid crystalline molecule, preferably in the range of 5 to 30% by mass.

Surfactants include conventionally well-known compounds, and especially fluorine compounds are preferable. Specific examples include compounds described in paragraphs [0028] to [0056] of Japanese Patent Application Laid-Open No. 2001-330725.

A polymer used together with a disc-shaped liquid crystalline molecule is preferably one which can impart the variation of the tilt angle to the disc-shaped liquid crystalline molecule.

An example of the polymer includes cellulose esters. Preferable Examples of cellulose esters include those described in paragraph [0178] of Japanese Patent Application Laid-Open No. 2000-155216. The addition amount of the above polymer is preferably in the range of 0.1 to 10% by mass to a liquid crystalline molecule so as not to inhibit the alignment of the liquid crystalline molecule, more preferably in the range of 0.1 to 8% by mass.

The transition temperature of the discotic nematic liquid crystal phase-solid phase of a disc-shaped liquid crystalline molecule is preferably 70 to 300° C., more preferably 70 to 170° C.

### (B-5) Formation of Optically Anisotropic Layers

An optically anisotropic layer can be formed by applying on an alignment film a coating liquid containing a liquid crystalline molecule, and, as required, a polymerization initiator described later and other components.

A solvent used for preparing the coating liquid is preferably an organic solvent. Examples of organic solvents include amides (e.g. N,N-dimethylformamide), sulfoxides (e.g. dimethylsulfoxide), heterocyclic compounds (I.e. pyridine), hydrocarbons (e.g. benzene and hexane), alkyl halides (e.g. chloroform, dichloromethane and tetrachloroethane), esters (e.g. methyl acetate and butyl acetate), ketones (e.g. acetone and methyl ethyl ketone), and ethers (e.g. tetrahydrofuran and 1,2-dimethoxyethane). Alkyl halides and ketones are preferable. Two or more organic solvents may be concurrently used.

Application of the coating liquid can be performed by well-known methods (for example, wire bar coating, extrusion coating, direct gravure coating, reverse gravure coating and die coating).

The thickness of an optically anisotropic layer is preferably 0.1 to 20 μm, more preferably 0.5 to 15 μm, most preferably 1 to 10 μm.

### (B-6) Fixation of an Alignment State of Liquid Crystalline Molecules

Aligned liquid crystalline molecules can be fixed while maintaining the alignment state. The fixation is preferably performed by a polymerization reaction. The polymerization reaction includes a thermal polymerization reaction using a thermal polymerization initiator and a photopolymerization reaction using a photopolymerization initiator. The photopolymerization reaction is preferable.

Examples of photopolymerization initiators include α-carbonyl compounds (described in the specifications of U.S. Pat. Nos. 2,367,661 and 2,367,670), acyloin ethers (described in the specification of U.S. Pat. No. 2,448,828), α-hydrocarbon-substituted aromatic acyloin compounds (described in the specification of U.S. Pat. No. 2,722,512), polynuclear quinone compounds (described in the specifications of U.S. Pat. Nos. 3,046,127 and 2,951,758), a combination of triarylimidazole dimmer and p-aminophenyl ketone (described in the specification of U.S. Pat. No. 3,549,367), acridine and phenazine compounds (described in Japanese Patent Application Laid-Open No. S60-105667 and U.S. Pat. No. 4,239,850), and oxadiazole compounds (described in the specification of U.S. Pat. No. 4,212,970).

The using amount of a photopolymerization initiator is preferably in the range of 0.01 to 20% by mass to the solid fraction of a coating liquid, more preferably in the range of 0.5 to 5% by mass.

The light irradiation for polymerization of liquid crystalline molecules preferably uses ultraviolet rays.

The irradiation energy is preferably in the range of 20 mJ/cm² to 50 J/cm², more preferably in the range of 20 mJ/cm² to 5,000 mJ/cm², still more preferably in the range of 100 mJ/cm² to 800 mJ/cm². For promoting the photopolymerization, light irradiation may be performed under a heating condition.

A protection layer may be provided on an optically anisotropic layer.

The optical compensation film and a polarization layer are preferably combined. Specifically, an optically anisotropic layer is formed by applying the above-mentioned coating liquid for an optically anisotropic layer on the surface of a polarization film. As a result, without using a polymer film between a polarization film and an optically anisotropic layer, a thin polarization plate having a low stress (strain×cross section×elastic modulus) involved in a dimensional change of the polarization film is fabricated. If the polarization plate according to the present invention is mounted on a large-size liquid crystal display apparatus, images of a high display quality can be displayed with no problems such as light leakage.

The stretching is performed preferably such that the slant angle between the polarization layer and the optical compensation layer matches an angle made by the transmission axis of two sheets of polarization plates laminated on both sides of a liquid crystal cell constituting an LCD and the longitudinal or lateral direction of the liquid crystal cell. The common slant angle is 45°. However, recently, transmission-type, reflection-type and semi-transmission-type LCDs of which the angle is not always 45° have been developed, so it is preferable that the stretching direction can be controlled optionally according to the design of LCDs.

### (B-7) Liquid Crystal Display Apparatus

Each liquid crystal mode using such an optical compensation film will be described.

### (TN Mode Liquid Crystal Display Apparatus)

TN mode liquid crystal display apparatuses are most often utilized as color TFT liquid crystal display apparatuses, and are described in many documents. The alignment state in a liquid crystal cell in black display apparatus of TN mode is such that rod-shaped liquid crystalline molecules stand up in the cell center part and they lie in the vicinities of the cell substrates.

### (OCB Mode Liquid Crystal Display Apparatus)

OCB mode liquid crystal display apparatuses are liquid crystal cells of bend alignment mode in which rod-shaped liquid crystalline molecules are aligned in substantially reverse directions (symmetrically) in the upper and lower parts of a liquid crystal cell. Liquid crystal display apparatuses using liquid crystal cells of bend alignment mode are disclosed in the specifications of U.S. Pat. Nos. 4,583,825 and 5,410,422. Since rod-shaped liquid crystalline molecules are aligned symmetrically in the upper and lower parts of a liquid crystal cell, the liquid crystal cell of bend alignment mode has a self-optical compensation function. Therefore, this liquid crystal mode is also named OCB mode (Optically Compensatory Bend) liquid crystal mode.

OCB mode liquid crystal cells have an alignment state in liquid crystal cells in black display apparatus as in TN mode, the alignment state being such that rod-shaped liquid crystalline molecules stand up in the cell center part and they lie in the vicinities of the cell substrates.

### (VA Mode Liquid Crystal Display Apparatus)

VA mode has a feature that rod-shaped liquid crystalline molecules are substantially vertically aligned at the time of no voltage impressed. The VA mode liquid crystal cells include (1) a narrowly-defined VA mode liquid crystal cell in which rod-shaped liquid crystalline molecules are substantially vertically aligned at the time of no voltage impressed and they are substantially horizontally aligned at a time of a voltage impressed (described in Japanese Patent Application Laid-Open No. 2-176625), besides, (2) a (MVA mode) liquid crystal cell in which VA mode is made of multi-domain for enlarging viewing angle (described in SID97, Digest of Tech. Papers (proceedings), 28 (1997), 845), (3) a liquid crystal cell of a mode (n-ASM mode) in which rod-shaped liquid crystalline molecules are substantially vertically aligned at the time of no voltage impressed and they are aligned in twisted multi-domain at a time of a voltage impressed (described in Proceedings of Japan Liquid Crystal Society Symposium, 58-59 (1998)), and (4) a SURVIVAL mode liquid crystal cell (presented at LCD International 98).

### (IPS Mode Liquid Crystal Display Apparatus)

IPS mode has a feature that rod-shaped liquid crystalline molecules are aligned substantially horizontally in the plane at the time of no voltage impressed, and a feature that this alignment direction of the liquid crystal is varied by the presence and absence of a voltage impression to perform switching. Usable IPS mode liquid crystal display apparatuses are specifically described in Japanese Patent Application Laid-Open Nos. 2004-365941, 2004-12731, 2004-215620, 2002-221726, 2002-55341 and 2003-195333.

### (Other Liquid Crystal Display Apparatus)

ECB mode and STN mode can also be optically compensated under the same consideration as the above described.

### (C) Imparting of a Reflection Preventing Layer (Reflection Preventing Film)

A reflection preventing film is formed generally by providing a low-refractive index layer being also an antifouling layer, and at least one layer having a refractive index higher than the low-refractive index layer (i.e. a high-refractive index layer, a middle-refractive index layer), on a transparent substrate.

Methods for forming a reflection preventing layer include a method in which a thin film as a multilayer film obtained by laminating transparent thin films of inorganic compounds (metal oxide, etc.) having different refractive indexes is formed by forming colloidal metal oxide particle films by the chemical vapor deposition (CVD) method, the physical vapor deposition (PVD) method, or the sol-gel method of metal compounds such as metal alkoxides and by post-treating (ultraviolet irradiation: Japanese Patent Application Laid-Open No. 9-157855, plasma treatment: Japanese Patent Application Laid-Open No. 2002-327310).

On the other hand, various types of reflection preventing films having a high productivity are proposed in which thin films in which inorganic particles are dispersed in a matrix are laminatedly coated.

The reflection preventing films also include one in which the reflection preventing film obtained by coating as described above has a reflection preventing layer as an uppermost layer whose surface has fine irregularities to impart antiglareness.

Any of the above-mentioned systems can apply to the thermoplastic resin film of the present invention, but most preferably, the system of coating (coating type) can.

### (C-1) Layer Structure of the Coating-Type Reflection Preventing Film

A reflection preventing film composed of a layer structure in order of at least a middle-refractive index layer, a high-refractive index layer and a low-refractive index layer (outmost layer) on a substrate is designed so as to have a refractive index satisfying the following relationship.

The refractive indexes have the relationship: a refractive index of a high-refractive index layer>a refractive index of a middle-refractive index layer>a refractive index of a transparent supporter>a refractive index of a low-refractive index layer. A hard coat layer may be provided between the transparent supporter and the middle-refractive index layer. Further, the reflection preventing film may be structured of a middle refractive index hard coat layer, a high-refractive index layer and a low-refractive index layer.

The reflection preventing films include, for example, those described in Japanese Patent Application Laid-Open Nos. 8-122504, 8-110401, 10-300902, 2002-243906 and 2000-111706.

Further, another function may be imparted to each layer, and examples thereof include a low-refractive index layer having antiglareness and a high-refractive index layer having antistaticity (for example, Japanese Patent Application Laid-Open Nos. 10-206603 and 2002-243906).

The haze of a reflection preventing film is preferably not more than 5%, more preferably not more than 3%. The strength of the film is preferably not less than H in terms of the pencil harness test according to JIS K5400, more preferably not less than 2H, most preferably not less than 3H.

### (C-2) High-Refractive Index Layer and Middle-Refractive Index Layer

A layer having a high refractive index of a reflection preventing film is composed of a curable film containing, at least, inorganic compound ultrafine particles having an average particle size of not more than 100 nm and a high refractive index, and a matrix binder.

The inorganic microparticle of a high refractive index includes an inorganic compound having a refractive index of not less than 1.65, preferably one having a refractive index of not less than 1.9. The inorganic microparticle includes, for example, oxides such as oxides of Ti, Zn, Sb, Sn, Zr, Ce, Ta, La and In, and compound oxides containing these metal atoms.

Making such ultrafine particles includes a treatment of the particle surface with a surface treating agent (for example, a silane coupling agent: Japanese Patent Application Laid-Open Nos. 11-295503, 11-153703 and 2000-9908, an anionic compound or an organometallic coupling agent: Japanese Patent Application Laid-Open No. 2001-310432, etc.), making a core-shell structure with a high refractive index particle as the core (Japanese Patent Application Laid-Open No. 2001-166104, etc.), and concurrent use of a specific dispersant (for example, Japanese Patent Application Laid-Open Nos. 11-153703 and 2002-2776069 and U.S. Pat. No. 6,210,858B1).

Materials forming a matrix include conventionally well-known thermoplastic resins and thermosetting resins.

Further, preferable is at least a composition selected from a composition containing a polyfunctional compound containing at least two polymerizable groups of radically polymerizable and/or cationically polymerizable groups, and a composition composed of an organometallic compound containing a hydrolysable group and its partial condensate. These include, for example, compounds described in Japanese Patent Application Laid-Open Nos. 2000-47004, 2001-315242, 2001-31871 and 2001-296401.

Besides, a colloidal metal oxide obtained from a hydrolyzed condensate of a metal alkoxide, and a curable film obtained from a metal alkoxide composition are also preferable. These are described, for example, in Japanese Patent Application Laid-Open No. 2001-293818.

The refractive index of a high-refractive index layer is commonly 1.70 to 2.20. The thickness of a high-refractive index layer is preferably 5 nm to 10 μm, more preferably 10 nm to 1 μm.

The refractive index of a middle-refractive index layer is adjusted so as to be a value between the refractive index of a low-refractive index layer and the refractive index of a high-refractive index layer. The refractive index of a middle-refractive index layer is preferably 1.50 to 1.70.

### (C-3) Low-Refractive Index Layer

A low-refractive index layer is formed by laminating it on a high-refractive index layer in order. The refractive index of a low-refractive index layer is 1.20 to 1.55, preferably 1.30 to 1.50.

A low-refractive index layer is preferably structured as an outermost layer having scratch resistance and fouling resistance. An effective method to largely improve the scratch resistance is imparting lubricity on the surface and conventionally well-known methods for thin films comprising incorporation of silicones and fluorine can be applied.

The refractive index of fluorine-containing compounds is preferably 1.35 to 1.50, more preferably 1.36 to 1.47. Further, the fluorine-containing compounds are preferably compounds containing a crosslinkable or polymerizable functional group containing fluorine atoms in the range of 35 to 80% by mass.

These include, for example, compounds described in paragraphs [0018] to [0026] of Japanese Patent Application Laid-Open No. 9-222503, paragraphs [0019] to [0030] of Japanese Patent Application Laid-Open No. 11-38202, paragraphs [0027] to [0028] of Japanese Patent Application Laid-Open No. 2001-40284, and Japanese Patent Application Laid-Open No. 2000-284102.

The silicone compounds are compounds having a polysiloxane structure, and are preferably those which contain a curable functional group or a polymerizable functional group in their polymer chains and have a crosslinking structure in the film. These include, for example, reactive silicones (for example, SILAPLANE, made by Chisso Corp.), a polysiloxane having silanol groups at both terminals (Japanese Patent Application Laid-Open No. 11-258403, etc.).

The crosslinking or polymerization reaction of a fluorine-containing polymer and/or a siloxane polymer having a crosslinkable or polymerizable group is preferably performed by irradiating with light or heating a coating composition for forming an outermost layer containing a polymerization initiator, a sensitizer and the like, simultaneously when applying the coating composition, or right after applying the coating composition.

In addition, a sol-gel curing film is preferable which is cured by condensation reaction of an organometallic compound such as a silane coupling agent, and a silane coupling agent containing a specific fluorine-containing hydrocarbon under coexistence of a catalyst.

This includes, for example, a polyfluoroalkyl group-containing silane compound or its partially hydrolyzed condensate (compounds described in Japanese Patent Application Laid-Open Nos. 58-142958, 58-147483, 58-147484, 9-157582 and 11-106704) and a silyl compound containing a poly(perfluoroalkyl ether) group being a fluorine-containing long chain group (compounds described in Japanese Patent Application Laid-Open Nos. 2000-117902, 2001-48590 and 2002-53804).

The low-refractive index layer can contain, as additives other than the above described, fillers (for example, silicon dioxide (silica), inorganic compounds having an average primary particle size of 1 to 150 nm and a low refractive index such as fluorine-containing particles (magnesium fluoride, calcium fluoride and barium fluoride), and organic microparticles described in paragraphs [0020] to [0038] of Japanese Patent Application Laid-Open No. 11-3820), a silane coupling agent, a lubricant, a surfactant and the like.

In the case where the low-refractive index layer is positioned at an underlayer of an outermost layer, the low-refractive index layer may be formed by the vapor phase method (vacuum vapor deposition, sputtering, ion plating, plasma CVD or the like). The coating method is preferable because this can manufacture the layer inexpensively.

The film thickness of a low-refractive index layer is preferably 30 to 200 nm, more preferably 50 to 150 nm, most preferably 60 to 120 nm.

### (C-4) Hard Coat Layer

A hard coat layer is provided on the surface of a transparent supporter for imparting a physical strength to the reflection preventing film. Particularly, it is preferably provided between the transparent supporter and the above-mentioned high-refractive index layer.

The hard coat layer is preferably formed by a crosslinking reaction or a polymerization reaction of a curable compound by light and/or heat.

As a curable functional group, a photopolymerizable functional group is preferable, and an organometallic compound containing a hydrolysable functional group is preferably an organic alkoxysilyl group.

Specific examples of these compounds include the similar compounds as exemplified in the high-refractive index layer.

Specific compositions constituting a hard coat include, for example, those described in Japanese Patent Application Laid-Open Nos. 2002-144913 and 2000-9908 and WO0/46617, etc.

A high-refractive index layer can serve simultaneously as a hard coat. In such a case, the layer is preferably formed by dispersing finely microparticles and making them contained in the hard coat layer by using the method described in the high-refractive index layer.

The hard coat layer also can serve simultaneously as an antiglare layer (described later) to which an antiglare function is imparted by making the hard coat layer contain particles having an average particle size of 0.2 to 10 μm.

The film thickness of a hard coat layer can be designed suitably according to applications. The thickness of a hard coat layer is preferably 0.2 to 10 μm, more preferably 0.5 to 7 μm.

The strength of a hard coat layer is preferably not less than H in terms of pencil hardness test according to JIS K5400, more preferably not less than 2H, most preferably not less than 3H. The less abrasion amount of test pieces after the Taber test in the Taber test according to JIS K5400 is more preferable.

### (C-5) Forward Scattering Layer

A forward scattering layer is provided for imparting an improving effect on the viewing angle when the viewing angle is tilted in the vertical and horizontal directions in the case of applying to a liquid crystal display apparatus. The forward scattering layer can serve simultaneously as a hard coat function by dispersing microparticles having a different refractive index in the above-mentioned hard coat.

These are described, for example, in Japanese Patent Application Laid-Open No. 11-38208 wherein the forward scattering factor is specified, Japanese Patent Application Laid-Open No. 2000-199809 wherein the relative refractive index of a transparent resin and a microparticle is set at a specified range, and Japanese Patent Application Laid-Open No. 2002-107512 wherein the haze value is prescribed at not less than 40%.

### (C-6) Other Layers

In addition to the layers described above, a primer layer, an antistatic layer, an undercoat layer and a protection layer may be provided.

### (C-7) Coating Method

Each layer of the reflection preventing layer can be formed by coating of dip coating, air knife coating, curtain coating, roller coating, wire bar coating, gravure coating, microgravure coating or extrusion coating (specification of U.S. Pat. No. 2,681,294).

### (C-8) Antiglare Function

The reflection preventing film may also have an antiglare function, which scatters external light. The antiglare function is obtained by forming irregularities on the surface of the reflection preventing film. In the case where the reflection preventing film has an antiglare function, the haze of the reflection preventing film is preferably 3 to 30%, more preferably 5 to 20%, most preferably 7 to 20%.

Any methods for forming irregularities on the surface of a reflection preventing film can be applied as long as they can sufficiently keep the surface shape. The methods include, for example, a method in which irregularities are formed on a film surface by using microparticles in a low-refractive index layer (e.g. Japanese Patent Application Laid-Open No. 2000-271878), a method in which a surface-irregular film is formed by adding a small amount (0.1 to 50% by mass) of relatively large particles (particle size of 0.05 to 2 μm) to an underlayer (a high-refractive index layer, middle-refractive index layer or hard coat layer) of a low-refractive index layer, and a low-refractive index layer is provided on the surface-irregular film while keeping the shape (e.g. Japanese Patent Application Laid-Open Nos. 2000-281410, 2000-95893, 2001-100004 and 2001-281407), and a method in which an irregular shape is transferred on the surface after the outermost layer (antifouling layer) is coated (for example, as emboss processing methods, described in Japanese Patent Application Laid-Open Nos. 63-278839, 11-183710, 2000-275401, etc.).

Features of the present invention will now be described in further detail with reference to Examples and Comparative Examples. Materials, amounts, percentages, processing details, procedures and the like as shown in the following Examples can be changed as appropriate without departing from the spirit of the present invention. Thus, the scope of the present invention should not be limited to the specific examples shown below.

### EXAMPLES

### Film-Forming of Saturated Norbornene Resin Film

Pellets (TOPAS5013 (Tg132° C.) manufactured by Polyplastics Co., Ltd.) of saturated norbornene resin (COC) by addition polymerization, pellets (Zeonor 1040R (Tg135° C.) manufactured by Nippon Zeon Corporation) of saturated norbornene resin (COP) by ring-opening polymerization) and pellets (Mitsui PET(Tg69° C.) manufactured by Mitsui Chemicals, Inc.) of polyester resin (PET) were dried at 100° C. with a dehumidified air having a dew point of 40° C. for five hours to reduce the water content below 0.01 wt %. These were cast into a hopper at 80° C. and the temperature of the melt extruder and the die was adjusted. The diameter of the screw (on the outlet side) used for this was 60 mm with L/D of 50 and a compression ratio of 4. The inlet side of the screw was cooled by circulating an oil at Tg of the pellet minus 5° C. through the inside of the screw. The residence time of the resin in the barrel was 5 minutes. The highest temperature and the lowest temperature of the barrel were set at the outlet and the inlet of the barrel respectively. The resin extruded out of the extruder was metered and sent out at a fixed rate with a gear pump, and at this time rotation frequency of the extruder was changed so that the resin pressure before the gear pump was able to be controlled at a fixed pressure of 10 MPa. The molten resin sent out from the gear pump was filtered by a leaf disk filter with a filtration precision of 5 μm and pushed out of a hanger coat die with a slit distance of 0.8 mm at 230° C. except 290° C. in Comparative Example 1, and solidified with a casting drum. In Examples 1 to 15, edge pinning method was used (with an electrode consisting of needle-like projections; which was installed at 10 cm from the landing point of the melt onto the casting drum) and the both end parts within 10 cm from the edges were charged with static electricity. In Comparative Examples 1 and 2, the full width was charged with static electricity by conventional wire pinning method. The applied voltage was 10 kV except 3 kV in Example 12, 15 kV in Example 13 and 18 kV in Example 14. The solidified melt was peeled off from the casting drum, and after subjected to trimming of the both end parts (respectively 5% of the full width) immediately before winding up and to thicknessing processing (knurling processing) of 50 μm in thickness and 10 mm in width at the both end parts, 3,000 m thereof was wound up at a rate of 30 m/min. The width of the thus obtained unstreched film was 1.5 m.

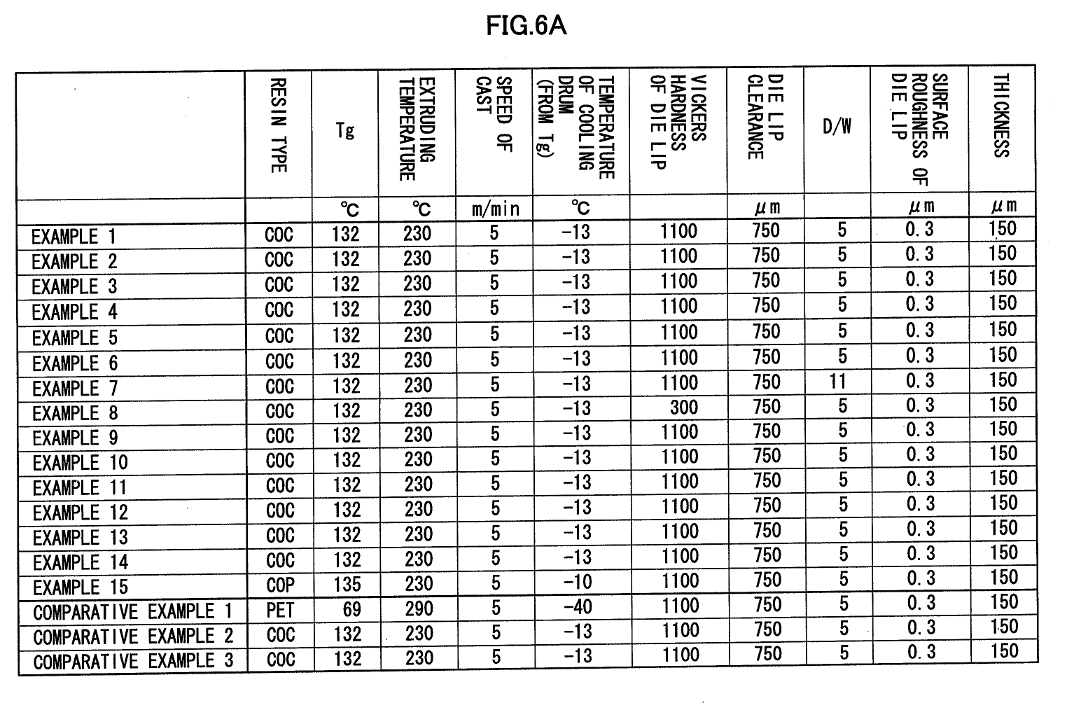

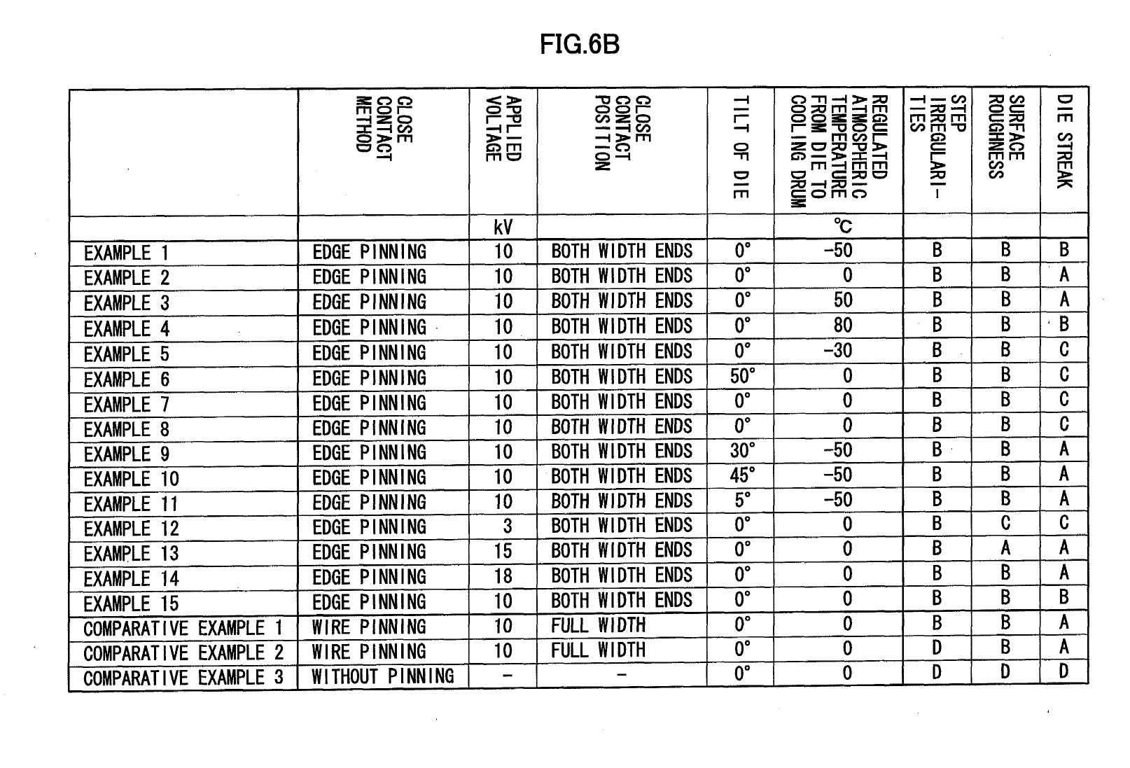

In the table of FIGS. 6A and 6B, the temperature of the cooling drum and the temperature from the die to the cooling drum (atmospheric temperature) were shown as “From Tg” with signs of “+” and “−” respectively meaning by what degree (° C.) those temperatures were higher or lower than the Tg of each resin of each Examples and Comparative Examples.

### (Evaluation Method of Step Irregularities)

The sheets were visually observed and those with observable step irregularities

were denoted with “D” and those without any observable step irregularity were denoted with “B”.

### (Surface Roughness)

The sheets were visually observed and those in which no surface roughness developed were denoted with “A”, those in which surface roughness scarcely developed were denoted with “B” and those in which surface roughness developed although not always were denoted with “C”.

### (Evaluation Method of Die Streaks)

The sheets were visually observed and those in which no die streaks developed were denoted with “A”, those in which die streaks scarcely developed were denoted with “B” and those in which die streaks developed although not always were denoted with “C”.

Examples 1 to 14 and Comparative Example 2 in the table of FIGS. 6A and 6B are examples in which the present invention was carried out using the same saturated norbornene resin, and the film-forming was effected under the same conditions except the atmospheric temperature of the circumference of the molten resin in the course of leaving the die to touching down the cooling. As is understood from Examples 1 to 14, no step irregularities were observed when the edge pinning which allows the only both end parts of the full width of the molten resin discharged from the die to contact to the cooling drum was performed.

In comparison among Examples 1 to 5, good results without any development of die streaks were observed in Examples 2 and 5 in which the atmospheric temperature of the circumference of the molten resin in the course of leaving the die to touching down the cooling drum was controlled in a range of glass transition temperature of the molten resin (Tg)−10° C. to Tg+50° C.

Comparative Example 2 is a case in which PET (polyethylene terephthalate) resin is subjected to close contact by wire pinning method, and different from the case of cellulose acylate resin of Comparative Example 1, no step irregularities are observed. It is understood from this that edged pinning method is particularly effective for cellulose acylate resin to prevent step irregularities. Comparative Example 1 is a case in which the full width of the molten resin discharged from the die was subjected to close contact treatment (wire pinning) onto the cooling drum, and different from Examples 1 to 14, step irregularities were observed.

Example 6 is a case in which the discharging angle to discharge the molten resin from the die was tilted at more than 45°, and die streaks developed although not always. In addition, it is understood from the comparison between Examples 9 to 11 and Example 1, when it is tilted in a range of 5° to 45° in the rotating direction of the cooling drum, there develop no die streaks.

Example 7 is a case in which the lip clearance ratio (D/W) is set in a range more than 10. Example 8 is a case in which the hardness of the lip surface of the die is less than 500 in terms of Vickers hardness. Example 7 and Example 8 had no difference in step irregularities in the comparison with Example 2 but the evaluation of die streaks deteriorated to some extent.

Examples 12 to 14 are cases in which the voltage applied to the electrode was set in a range of 2 to 20 kV. It is understood from the comparison with Comparative Example 3 that the evaluations of step irregularities, surface roughness and die streaks were improved by setting the voltage applied to the electrode in a range of 2 to 20 kV.

Example 15 is an example in which a saturated norbornene resin by ring-opening polymerization (COP) was used, and in the comparison of a saturated norbornene resin which was a copolymer of norbornene and ethylene (COC) under the same condition, better evaluation was obtained in the development of die streaks in the case of using COC than in the case of using COP.

### [Preparation of Polarization Plate]

The following polarization plates were prepared from unstreched films of the table of FIGS. 6A and 6B.

The surface of the film was subjected to corona treatment so that the contact angle between the surface and water became 60°.

According to Example 1 of Japanese Patent Application Laid-Open No. 2001-141926, two pairs of nip rolls were imparted with difference in circumferential speed so as to stretch the film in the longitudinal direction, and thereby a polarization layer having a thickness of 20 μm was prepared.

These are laminated according to the following constitution using a 3% aqueous solution of PVA (PVA-117H manufactured by Kuraray Co., Ltd.) as an adhesive, and thereby a laminated polarization plate was prepared

Polarization plate E: saturated norbornene film/polarization layer/FUJITAC

The thus obtained polarization plate was attached in place of the polarization plate of the 50-inch VA type liquid crystal display apparatus prepared in accordance with FIGS. 2 to 9 of Japanese Patent Application Laid-Open No. 2000-154261. The product manufactured by carrying out the present invention had no area defects and good performance was obtained.

### [Preparation of Optical Compensation Film]

In substitution for the cellulose acetate film on which a liquid crystal layer was applied in Example 1 of Japanese Patent Application Laid-Open No. 11-316378, saturated norbornene films of the present invention were used. Those according to the present invention showed good performance.

Good optical compensation films were also able to be prepared using saturated norbornene films of the present invention in substitution for the cellulose acetate film on which a liquid crystal layer was applied in Example 1 of Japanese Patent Application Laid-Open No. 7-333433. Above all, saturated norbornene resin (COC) which was a copolymer of norbornene and ethylene by addition polymerization was good.

### [Preparation of Low Reflection Film]

Good optical performance was obtained when a low reflection film was prepared using saturated norbornene films of the present invention in accordance with Example 47 of Japan Institute of Invention and Innovation Journal of Technical Disclosure No. 2001-1745. Above all, saturated norbornene resin (COC) which was a copolymer of norbornene and ethylene by addition polymerization was good.

### [Production of Liquid Crystal Display Apparatus Element]

The polarization plate of the present invention was used in the liquid crystal display apparatus described in Example 1 of Japanese Patent Application Laid-Open No. 10-48420, an optical anisotropic layer containing discotic liquid crystal molecules described in Example 1 of Japanese Patent Application Laid-Open No. 9-26572, an alignment film coated with polyvinyl alcohol, a 50-inch VA type liquid crystal display apparatus prepared in accordance with FIGS. 2 to 9 of Japanese Patent Application Laid-Open No. 2000-154261, a 50-inch OCB type liquid crystal display apparatus prepared in accordance with FIGS. 10 to 15 of Japanese Patent Application Laid-Open No. 2000-154261, and an IPS type liquid crystal display apparatus described in FIG. 11 of Japanese Patent Application Laid-Open No. 2004-12731. Furthermore, a low reflection film of the present invention was applied on the most outer layer of these liquid crystal display apparatuses and evaluated, and good liquid crystal display apparatus devices were obtained. Above all, saturated norbornene resin (COC) which was a copolymer of norbornene and ethylene by addition polymerization was good.

What is claimed is:

1. A method for producing a saturated norbornene resin film by melt film-forming method comprising discharging a molten resin molten in an extruder in a form of a sheet onto a traveling or rotating cooling support from a die so as to be solidified by cooling, wherein
the molten resin discharged from the die is subjected to a close contact treatment which allows only the both end parts of the full width of the molten resin to closely contact to the cooling support.

2. The method for producing a saturated norbornene resin film according to claim 1, wherein the close contact treatment is a treatment which charges the both end parts of the molten resin in the width direction with static electricity to allow only the both end parts of the full width of the molten resin to closely contact to the cooling support by the charged static electricity.

3. The method for producing a saturated norbornene resin film according to claim 1, wherein relation between orientation in width direction (TD direction) and orientation in film flow direction (MD direction) of the saturated norbornene resin film which is formed by conducting the close contact treatment is a relation in which the orientation in the MD direction is larger than the orientation in the TD direction.

4. The method for producing a saturated norbornene resin film according to claim 2, wherein an electrode including one or more needle-like projections is used to charge the static electricity.

5. The method for producing a saturated norbornene resin film according to claim 4, wherein a voltage of 2 to 20 kV is applied to the electrode in the close contact treatment.

6. The method for producing a saturated norbornene resin film according to claim 1, wherein an atmospheric temperature around the molten resin in the course of leaving the die to touching down on the cooling support is controlled to a range of glass transition temperature of the molten resin (Tg)−10° C. to Tg+50° C.

7. The method for producing a saturated norbornene resin film according to claim 1, wherein a temperature of the cooling support is in a range of glass transition temperature of the molten resin (Tg) to Tg−30° C., and the cooling support has a traveling or rotating speed in a range of 1 to 50 m/min.

8. The method for producing a saturated norbornene resin film according to claim 1, wherein a lip clearance of the die is set in a range of 300 to 1500 μm, and a lip clearance ratio (D/W) which is a ratio of the lip clearance (D) of the die to the thickness (W) of the molten resin discharged from the die is set to a range of 1.5 to 10.

9. The method for producing a saturated norbornene resin film according to claim 1, wherein a discharging angle to discharge the molten resin from the die is set in a range of 0° to 45° along a traveling or rotating direction of the cooling support assuming that the vertical direction is 0°.

10. The method for producing a saturated norbornene resin film according to claim 1, wherein a centerline average roughness (Ra) of a lip surface of the die is not more than 0.5 μm and a curvature radius (R) of an edge part of the lip on a discharge outlet side is not more than 50 μm.

11. The method for producing a saturated norbornene resin film according to claim 1, wherein a hardness of the lip surface of the die is not less than 500 in terms of Vickers hardness.

12. The method for producing a saturated norbornene resin film according to claim 1, wherein the saturated norbornene resin is a copolymer of norbornene and ethylene.

13. A method for producing a stretched saturated norbornene resin film comprising stretching a saturated norbornene resin film before stretching at least one direction of the longitudinal direction and the transverse direction of the film by not less than 1% and not more than 300%, wherein
the saturated norbornene resin film before stretching is produced by the method of claim 1.

14. The method for producing a stretched saturated norbornene resin film according to claim 13, wherein the stretching results in an in-plane retardation (Re) of not less than 50 nm.

15. An apparatus for producing a saturated norbornene resin film by melt film-forming method which comprises discharging a molten resin molten in an extruder in a form of a sheet onto a traveling or rotating cooling support from a die so as to be solidified by cooling, the apparatus comprising:
a device for achieving close contact at both end parts which allows only the both end parts of the full width of the molten resin discharged from the die to closely contact to the cooling support; and
a device for regulating atmospheric temperature which regulates an atmospheric temperature around the molten resin in the course of leaving the die to touching down on the cooling support.

16. The apparatus for producing a saturated norbornene resin film according to claim 15, wherein the device for regulating atmospheric temperature comprises:
a tubular surrounding member which surrounds the molten resin in the course of leaving the die to touching down on the cooling support;
a heating device which heats the surrounding member;
a temperature sensor which measures the atmospheric temperature within the surrounding member; and
a controlling device which controls heating temperature of the heating device based on the atmospheric temperature measured with the temperature sensor.
